(19) United States
(12) Patent Application Publication
(10) Pub. No.: US 2026/0245321 A1
(43) Pub. Date: Aug. 20, 2026

(54) METHOD AND APPARATUS FOR VIRTUAL GARMENT REPLACING BASED ON A GARMENT REPLACEMENT MODEL

(71) Applicant: Beijing Zitiao Network Technology Co., Ltd., Beijing (CN)

(72) Inventors: Feida ZHU, Beijing (CN); Xin DONG, Beijing (CN); Youjiang XU, Beijing (CN); Yuxuan LUO, Beijing (CN); Shilei WEN, Beijing (CN)

(21) Appl. No.: 19/161,695

(22) PCT Filed: Mar. 14, 2024
(86) PCT No.: PCT/CN2024/081784

§ 371 Date: Sep. 2, 2025

(30) Foreign Application Priority Data
Mar. 27, 2023 (CN) 202310303955.3

(51) Int. Cl. G06T 19/20; G06T 7/11; G06T 7/194; G06T 7/73; G06T 15/40

(52) U.S. Cl. CPC G06T 19/20; G06T 7/11; G06T 7/194; G06T 7/74; G06T 15/40; G06T 2207/20081; G06T 2207/20084; G06T 2207/20221; G06T 2207/30196; G06T 2210/16; G06T 2219/2021

(57) ABSTRACT

Embodiment of the disclosure provides a method and apparatus for virtual garment replacing based on a garment replacement model The method includes: obtaining first feature information comprising garment information of a first garment from a first image, and obtaining second feature information comprising body shape and pose information of an object to be garment-replaced from a second image corresponding to the first image; with the feature extraction module, determining a plurality of first feature maps based on the first feature information, and determining a plurality of second feature maps based on the second feature information; and with the deformation generative module, determining a target generative image based on the plurality of first feature maps, the plurality of second feature maps, an initial intermediate feature and a corresponding initial generative image.

### CROSS REFERENCE TO RELATED APPLICATIONS

This application is a national phase application based on International Patent Application No. PCT/CN2024/081784, filed on Mar. 14, 2024, which claims priority to Chinese Patent Application No. 202310303955.3, entitled ‘METHOD AND APPARATUS FOR VIRTUAL GARMENT REPLACING BASED ON A GARMENT REPLACEMENT MODEL,’ filed on Mar. 27, 2023, the entire contents of which are incorporated herein by reference in their entireties.

### FIELD

The present specification relates to the field of image processing technologies, and in particular, to a method and apparatus for virtual garment replacing based on a garment replacement model.

### BACKGROUND

The garment migration (or referred to as garment replacement) may refer to migrating a first garment worn by a first object in a first object image (for example, a human body image) to a second object in a second object image to obtain a new object image including a second object wearing the first garment (maintaining the pose thereof in the second object image). The garment migration may show the try-on effect of the object to different garments in a virtual manner. In order to obtain a better garment migration effect, it is usually necessary to appropriately deform the garment that needs to be migrated during the migration process, so that the deformed garment is adapted to the limb form (for example, the pose, the body shape, etc.) of the target object (the object to which the garment is to be migrated).

Therefore, how to provide a method for garment migration that may obtain a better garment migration effect becomes an urgent problem to be solved.

### SUMMARY

One or more embodiments of the present specification provide a method and apparatus for virtual garment replacing based on a garment replacement model, so as to achieve a better garment migration (garment replacement) effect, that is, to obtain a deformed garment worn on an object (for example, a person) that needs to be garment-replaced to better conform to a limb form of the object.

According to a first aspect, a method for virtual garment replacing based on a garment replacement model is provided, the garment replacement model including a generative model that includes a feature extraction module and a deformation generative module; and the method includes: obtaining first feature information including garment information of a first garment from a first image, and obtaining second feature information including body shape and pose information of an object to be garment-replaced from a second image corresponding to the first image; with the feature extraction module, determining a plurality of first feature maps based on the first feature information, and determining a plurality of second feature maps based on the second feature information, the plurality of second feature maps including body shape features and pose features corresponding to the body shape and pose information of the object to be garment-replaced; and with the deformation generative module, determining a target generative image based on the plurality of first feature maps, the plurality of second feature maps, a randomly generated initial intermediate feature and a corresponding randomly generated initial generative image, the target generative image including an object to be garment-replaced wearing a deformed first garment, and the deformed first garment conforming to the body shape feature and pose feature of the object to be garment-replaced.

According to a second aspect, an apparatus for virtual garment replacing based on a garment replacement model is provided, the garment replacement model including a generative model that includes a feature extraction module and a deformation generative module; and the apparatus includes: a first obtaining module configured to obtain first feature information including garment information of a first garment from a first image, and obtaining second feature information including body shape and pose information of an object to be garment-replaced from a second image corresponding to the first image; a first determining module configured to, with the feature extraction module, determine a plurality of first feature maps based on the first feature information, and determining a plurality of second feature maps based on the second feature information, the plurality of second feature maps including body shape features and pose features corresponding to the body shape and pose information of the object to be garment-replaced; and a second determining module configured to, with the deformation generative module, determine a target generative image based on the plurality of first feature maps, the plurality of second feature maps, a randomly generated initial intermediate feature and a corresponding randomly generated initial generative image, the target generative image including an object to be garment-replaced wearing a deformed first garment, and the deformed first garment conforming to the body shape feature and pose feature of the object to be garment-replaced.

According to a third aspect, a computer-readable storage medium having a computer program stored thereon is provided, the computer program, when executed in a computer, causing the computer to execute the method of the first aspect.

According to a fourth aspect, an electronic device including a memory and a processor is provided, wherein the memory stores executable code, which, when executed by the processor, implementing the method of the first aspect.

### BRIEF DESCRIPTION OF DRAWINGS

In order to more clearly illustrate the technical solutions of the embodiments of the present disclosure, the accompanying drawings used in the description of the embodiments are briefly introduced below. Obviously, the drawings in the following description are only some embodiments of the present disclosure, and for those of ordinary skill in the art, further drawings may be obtained according to these drawings without creative work.

FIG. 1A is a schematic flowchart of a training method for virtual garment replacing according to an embodiment;

FIG. 1B is a schematic structural diagram of a generative model;

FIG. 2A and FIG. 2B are schematic structural diagrams of a feature deformation generator, respectively;

FIG. 3 is a further schematic flowchart of a method for virtual garment replacing based on a garment replacement model according to an embodiment;

FIG. 4 is a schematic block diagram of an apparatus for virtual garment replacing based on a garment replacement model according to an embodiment;

FIG. 5 is a schematic block diagram of an apparatus for training a garment replacement model according to an embodiment; and

FIG. 6 is a schematic block diagram of an electronic device according to an embodiment.

### DETAILED DESCRIPTION

The technical solutions of embodiments of the present specification would be described in detail below with reference to the accompanying drawings.

It would be appreciated that, before the technical solutions disclosed in the embodiments of the present disclosure are used, the types of personal information related to the present disclosure, the usage scope, the usage scenario and the like would inform the user in an appropriate manner according to the relevant laws and regulations and obtain the authorization of the user.

For example, in response to receiving an active request from a user, prompt information is sent to the user to explicitly prompt the user that the requested operation will need to obtain and use the personal information of the user. Therefore, the user may autonomously select whether to provide personal information to software or hardware executing the operation of the technical solution of the present disclosure according to the prompt information.

As an optional but non-limiting implementation, in response to receiving an active request of the user, the manner of sending the prompt information to the user may be, for example, a pop-up window, and the prompt information may be presented in a text manner in the pop-up window. In addition, the pop-up window may further carry a selection control for the user to select ‘agree’ or ‘disagree’ to provide personal information to the electronic device.

It would be appreciated that the foregoing notification and process of obtaining a user authorization is merely illustrative, and does not constitute a limitation on implementations of the present disclosure, and other manners of satisfying related laws and regulations may also be applied to implementations of the present disclosure.

A method and apparatus for virtual garment replacing based on a garment replacement model provided in this specification are described in detail below with reference to specific embodiments.

It would be appreciated that the training process of the virtual garment replacement and garment replacement model based on the garment replacement model provided in the embodiments of the present specification includes two stages, a training process of a first-phase garment replacement model (also referred to as a garment migration model), and a virtual garment replacement process based on a garment replacement model. For clarity of layout, a training process of the garment replacement model is first described below.

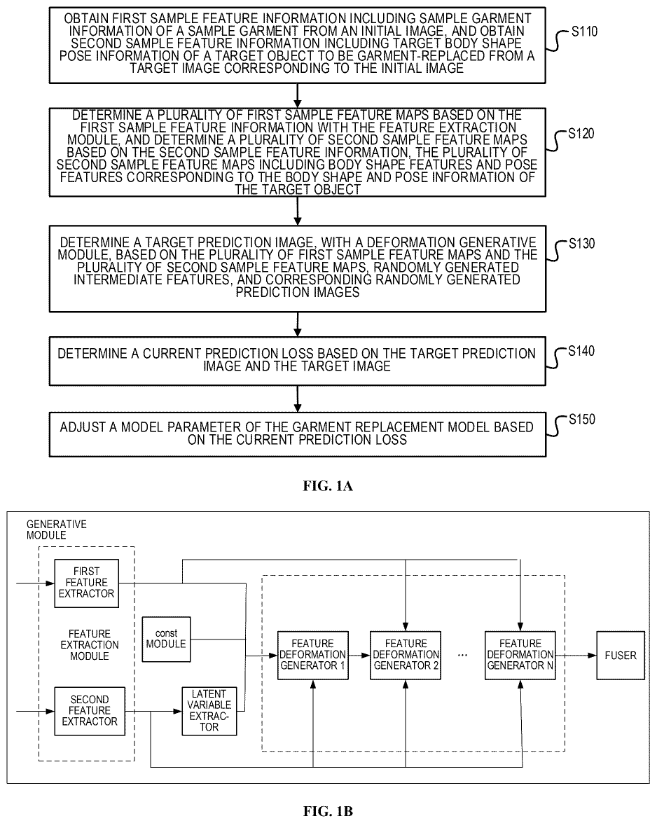

In a first stage (a training process of a garment replacement model), as shown in FIG. 1A, a schematic flowchart of a training method for a garment replacement model in an embodiment of the present specification is shown. As shown in FIG. 1B, the garment replacement model may include a generative model including a feature extraction module and a deformation generative module. The method may be implemented by a target program. The target program may be installed in an electronic device, and the electronic device may be implemented by any apparatus, device, platform, device cluster, or the like having computing and processing capabilities. As shown in FIG. 1, the method includes the following steps.

At Step S110, first sample feature information including sample garment information of a sample garment is obtained from an initial image, and second sample feature information including target body shape pose information of a target object to be garment-replaced is obtained from a target image corresponding to the initial image.

In this specification, the target program may first obtain training data for training a garment replacement model. The training data may include a plurality of sample image pairs, and each sample image pair includes an initial image and a target image. In an implementation, the initial image includes at least sample garment information of the sample garment, and the target image includes an object to be garment-replaced (referred to as a target object). In yet a further implementation, the initial image may include an object (which may be referred to as an initial object) wearing the sample garment. The trained model garment replacement model may generate a new image, wherein the new image includes the body shape of the target object, the pose of the target object presented in the target image, and the object wearing the sample garment (that is, the target object in the target image). The effect of migrating the sample garment to the target object and garment-replacing the target object is implemented. In one implementation, the object may be a person.

After obtaining the training data, the garment replacement model may be trained based on each sample image pair in the training data. It would be appreciated that, in the training process of the garment replacement model, the process of training the garment replacement model with each sample image pair is similar, and correspondingly, the training process of the garment replacement model is described by taking a pair of sample image pairs as an example.

Specifically, after obtaining the initial image and the corresponding target image, on one hand, feature information (referred to as the first sample feature information) including sample garment information of the sample garment therein is obtained from the initial image.

In an embodiment, the key points may be extracted from the initial image with a predetermined key point extraction algorithm, and the extracted key points may be classified into the first sample feature information. It would be appreciated that the key points extracted from the initial image may include key points corresponding to the sample garment, and key points corresponding to the sample garment have some correspondence with the limb key points. For example, when the sample garment includes a top, a left shoulder key point of the top may correspond to a left shoulder key point of the limb, a right shoulder key point of the top may correspond to a right shoulder key point of the limb, and a neck key point of the top may correspond to a neck key point of the limb. The types of the key points are for example only, do not constitute a limitation on the types of the key points corresponding to the extracted sample garment, and any key point type that may describe the corresponding information of the sample garment may be applied to the embodiments of the present specification. For example, the key points corresponding to the sample garment may further include contour key points corresponding to the sample garment, the key points of lower yaw of the top, and the like, the sample garment may also be (or may be referred to as) a bottom (for example, a pant, a dress, etc.), and correspondingly, the key points corresponding to the sample garment may further include key points corresponding to the bottom.

Then, the image of the region wherein the sample garment is located may be extracted from the initial image with a predetermined foreground extraction algorithm, and the first sample feature information is merged. Each part of the sample garment may also be recognized from the initial image with an region recognition algorithm, to obtain part segmentation information, wherein each part of the sample garment may include, but is not limited to: a left sleeve part, a trunk part, and a right sleeve part that are used as a top, and the like, a left leg part and a right leg part of the trousers, and the like, and waist and abdomen parts and skirt parts of the skirt, and the like.

In yet a further embodiment, the initial image may include an initial object wearing the sample garment. Correspondingly, the limb key points of the initial object may be extracted from the initial image based on the limb key point extraction algorithm, to obtain initial limb key point information. The initial limb key point information may be classified into the first sample feature information. The initial limb key point information may exist in an image form, including the extracted limb key points of the initial object.

In an implementation, the limb key points of the initial object may include limb key points of the trunk part, such as trunk contour key points, limb key points of the extremities, such as left and right leg key points, hip key points, knee joint key points, and the like. Such key points may represent garment information of the sample garment, and the limb key points of each trunk part may have some correspondence with key points of the sample garment. In still a further implementation, the limb key points of the initial object may further include head key points (which may include but are not limited to limb key points such as ears, eyes, ports, nose, and facial contour), hand key points (which may include but are not limited to limb key points such as a finger or a palm center), and foot key points (which may include but are not limited to limb key points such as an ankle and a foot surface), and the like. In this specification, the extracted limb key points may include any type of limb key points that need to be recognized in the related art, which is not limited herein.

In order to obtain the garment information and the limb information of the richer sample garment, the limb region information (referred to as initial limb region information) may be extracted from the initial image, and the first sample feature information is merged. The initial limb region information may include an image of a region wherein a limb of the initial object is located, and the initial limb region information includes garment information and limb information of sample garment such as a color and a texture of the sample garment, wherein the limb information may include information about a limb part of wearing a garment, or information about a limb part not wearing the garment. The initial limb region information may exist in an image form.

In addition, 3D limb pose information (referred to as initial limb pose information) of the initial object may be recognized from the initial image, and the 3D limb pose information is merged into the first sample feature information, wherein the initial limb pose information includes limb contour information of the initial object (that is, includes sample garment contour information), and may exist in an image form. In an implementation, the initial limb pose information may be a 3D limb image obtained based on rendering an SMPL model, which represents 3D limb pose information and contour information of an initial object in the initial image.

Then, limb segmentation information (referred to as initial limb segmentation information) of the initial object may be extracted from the initial image, the initial limb segmentation information includes information representing each part of the limb. Each part of the limb may include, but is not limited to, a head, a limb, a trunk, a hand, and a foot. The initial limb segmentation information may further include segmentation information of each part of the sample garment, for example, may include but is not limited to: top and bottom, etc., the initial limb segmentation information may exist in an image form, and different parts may be represented by different pixel values. The initial limb segmentation information may include body shape and pose information of the initial object.

Correspondingly, the first sample feature information may include: initial limb region information (including sample garment information such as color, texture, contour, and the like of the sample garment), initial limb key point information (which may represent key points of the initial object 2D limb pose information, and information representing pose and deformation of the sample garment), initial limb pose information (which may represent information such as the initial object and the 3D pose and deformation condition of the sample garment worn by the initial object), and initial limb segmentation information (which may represent body shape and pose information of the initial object, or may provide deformation of the sample garment).

On the other hand, feature information (referred to as second sample feature information) including body shape and pose information of a target object to be garment-replaced is obtained from the target image. Specifically, the limb segmentation information of the target object is extracted from the target image, referred to as target limb segmentation information, and is classified into the second sample feature information. The target limb segmentation information includes information representing parts of limbs of the target object, and each part of the limb may include, but is not limited to, a head, a limb, a trunk, a hand, and a foot (and an upper body and a lower body), the initial limb segmentation information may exist in an image form, and different parts may be represented by different pixel values. In this specification, the target limb segmentation information includes body shape and pose information of the target object.

In order to ensure the garment replacement effect, the limb key points of the target object may be extracted from the target image to obtain the target limb key point information, and the target limb key point information may be classified into the second sample feature information, which may exist in an image form. The limb key points in the target limb key point information may include any type of limb key points that may be extracted in the related art.

The 3D limb pose information (referred to as target limb pose information) of the target object may also be recognized from the target image, and the second sample feature information is classified, wherein the target limb pose information includes the body contour information of the target object, and may exist in an image form. In an implementation, the target limb pose information may be a 3D limb image obtained through rendering based on an SMPL model, which represents 3D limb pose information and contour information of the target object in the target image.

Considering that the color and texture of the garment worn by the target object in the target image may affect the garment replacement effect of the garment replacement model, correspondingly, the limb region information (referred to as target limb region information) of the target task may be extracted from the target image, wherein the target limb region information does not include the garment wearing region of the target object, but includes the non-garment wearing region of the target object. On one hand, considering that the head, hand, and foot of the target object generally do not belong to the garment wearing region, and during garment replacement (i.e., garment migration), it is expected that the head, hand and foot of the target object remain unchanged. Correspondingly, the part that does not belong to the garment wearing region may be set as the predetermined protection region (for example, the head, hand and foot of the object). Accordingly, the target limb region information extracted from the target image may include the predetermined protection region, for example, the region wherein the head, hand and foot of the target object are located.

In an implementation, the initial object in the initial image and the target object in the target image may be the same real object. In the initial image and the target image, the real object may be a person wearing the same set of garments (sample garment) in different poses. In a further implementation, the initial object in the initial image and the target object in the target image may be different real objects. In the initial image and the target image, the initial object and the target object may be persons wearing the same set of garments (sample garment) or different garments, in different poses.

After the first sample feature information of the initial image and the second sample feature information of the target image are obtained in the foregoing manner, at step S120, a plurality of first sample feature maps are determined based on the first sample feature information with the feature extraction module, a plurality of second sample feature maps are determined based on the second sample feature information, and the plurality of second sample feature maps include body shape features and pose features corresponding to the body shape and pose information of the target object.

In an implementation, the first sample feature information may be input into the feature extraction module, so that the feature extraction module performs feature extraction on the first sample feature information to obtain a plurality of first sample feature maps. Then, the second sample feature information is input into the feature extraction module, so that the feature extraction module performs feature extraction on the second sample feature information to obtain a plurality of second sample feature maps. The plurality of first sample feature maps may include at least a garment feature (for example, a color, a texture, a contour, etc.) of the sample garment, and may further include a limb feature (for example, a pose and a body shape) of the initial object. In fact, for any of the first sample feature maps, it is output by an intermediate layer or some intermediate sub-extraction module (for example, each first sub-extractor of the first feature extractor mentioned subsequently) in the feature extraction module, and correspondingly, any of the first sample feature maps may include at least one of the foregoing garment features (e.g., color, texture, contour, etc.) and/or limb features (e.g., pose and body shape). In this specification, each first sub-extractor may include a sub-extractor of a non-last layer in the first feature extractor.

The plurality of second sample feature maps as a whole include a body shape feature corresponding to the body shape and pose information of the target object, and may further include a pose feature representing the pose information of the target object. When the second sample feature information further includes the target limb key point information and the target second limb pose information, the plurality of second sample feature maps may further as a whole include a pose feature that may better represent the pose information of the target object. In fact, for any of the second sample feature maps, it is output by a certain layer in the feature extraction module or a certain sub-extraction module (for example, each sub-extractor of the second feature extractor mentioned subsequently). Correspondingly, any of the second sample feature maps may include at least one of the foregoing body type features and pose features. The target limb region information may include limb features (e.g., features of the head, hand, and foot) of the non-garment coverage region of the target object.

In a further implementation, as shown in FIG. 1B, the feature extraction module may include a first feature extractor and a second feature extractor that are set in parallel. Specifically, the first sample feature information is input into the first feature extractor, the first feature extractor performs feature extraction on the first sample feature information to obtain a plurality of first sample feature maps, wherein sizes of the plurality of first sample feature maps are different. The second sample feature information is input into a second feature extractor, and feature extraction is performed on the second sample feature information by the second feature extractor to obtain a plurality of second sample feature maps, wherein sizes of the plurality of second sample feature maps are different. The first feature extractor and the second feature extractor may be any type of extractor for feature extraction in the related art, which is not limited in the embodiments of the present specification.

In an implementation, image sizes of the respective first sample feature maps in the plurality of first sample feature maps are different, and image sizes of the respective second sample feature maps in the plurality of second sample feature maps are different. In one case, image sizes of several first sample feature maps (several second sample feature maps) are sequentially incremented, for example, several first sample feature maps (several second sample feature maps) may include first sample feature maps (second sample feature maps) with image sizes of 2ⁿ*2ⁿ, 2ⁿ⁺¹*2ⁿ⁺¹, . . . 2^{n+m}*2^{n+m}. For example, the plurality of first sample feature maps include first sample feature maps corresponding to 8*8, 16*16, 32*32, 64*64, 128*128, 256*256, and 512*512 image sizes, respectively. Similarly, the plurality of second sample feature maps include second sample feature maps respectively corresponding to 8*8, 16*16, 32*32, 64*64, 128*128, 256*256, and 512*512 image sizes. It may be considered that the higher the image size, the corresponding sample feature map includes more detail image features, and the sample feature map with a lower image size includes a relatively global image feature. In an implementation, the plurality of first sample feature maps may be feature maps output by each first sub-extractor. Correspondingly, the second feature extractor may include a plurality of second sub-extractors, and the plurality of second sample feature maps may be feature maps outputted by the respective second sub-extractors. The respective second sub-extractor may include a sub-extractor of a non-last layer in the second feature extractor.

After the plurality of first sample feature maps and the plurality of second sample feature maps are obtained, at step S130, a target prediction image is determined, with a deformation generative module, based on the plurality of first sample feature maps and the plurality of second sample feature maps, randomly generated intermediate features, and corresponding randomly generated prediction images. The target prediction image includes a second object wearing the deformed sample garment, and the deformed sample garment conforms to the body shape features and the pose features of the second object.

As shown in FIG. 1B, the generative model may further include an initialization module, that is, a const module. In one implementation, the const module may randomly generate an intermediate feature F_{GAN}⁰ and its corresponding prediction image I⁰ as the input of the deformation generative module. The prediction image I⁰ may be a color image, such as an RGB image. Herein, the intermediate feature F_{GAN}⁰ may exist in an image form.

In this step, the plurality of first sample feature maps, the plurality of second sample feature maps, the randomly generated intermediate feature F_{GAN}⁰ and its corresponding randomly generated prediction image I⁰ are input into the deformation generative module, so that the deformation generative module processes the plurality of first sample feature maps, the plurality of second sample feature maps, the randomly generated intermediate feature, and the corresponding randomly generated prediction image. Specifically, a plurality of first sample feature maps and a plurality of second sample feature maps are used to process the randomly generated intermediate feature F_{GAN}⁰ and its corresponding randomly generated prediction image I⁰, and then the processed intermediate feature and the processed prediction image are used to obtain a target prediction image, so as to deform the sample garment (that is, the limb of the initial object) based on the body shape feature (and the pose feature) of the target object, to obtain a deformed sample garment that conforms to the body shape feature (and the pose feature) of the target object, to generate a target prediction image including the target object wearing the deformed sample garment, to implement garment-replacing of the target object, that is, the sample garment is migrated to the body of the target object.

In an embodiment, in order to better improve the garment replacement capability of the garment replacement model and ensure the garment replacement effect, as shown in FIG. 1B, the generative model may further include a latent variable extractor, the second feature extractor in the feature extraction module further determines a sample feature extraction result based on the second sample feature information. Correspondingly, the latent variable extractor is configured to extract, from the sample feature extraction result, an abstracted latent variable vector representing the body type feature and the pose feature of the target object. In an implementation, the sample feature extraction result may be a sample result (for example, a result in a form of a feature map or a result in a form of a vector) output by a last layer of the sub-extractor in the foregoing second feature extractor.

Correspondingly, at step S130, the target prediction image may be determined based on the plurality of first sample feature maps and the plurality of second sample feature maps, the latent variable vector, the randomly generated intermediate features, and the corresponding randomly generated prediction images. The target program may process the randomly generated intermediate feature and its corresponding randomly generated prediction image with a plurality of first sample feature maps, a plurality of second sample feature maps, and a latent variable vector, so as to obtain the target prediction image with the processed intermediate feature and the processed prediction image. Thus, the object pose and the body shape in the target prediction image are more attached to the pose and body shape of the target object in the target image, thereby improving the garment replacement effect.

In an implementation, in order to generate an image with higher definition, as shown in FIG. 1B, the deformation generative module includes a plurality of feature deformation generators arranged in series (for example, as shown in FIG. 1B, including a feature deformation generator 1, a feature deformation generator 2, . . . , a feature deformation generator N), output image sizes corresponding to the plurality of feature deformation generators are sequentially increased. A plurality of first sample feature maps in the plurality of first sample feature maps respectively have some correspondence with each feature deformation generator, and each second sample feature map in the plurality of second sample feature maps has some correspondence with each feature deformation generator, for example, the corresponding output image sizes of each feature deformation generator in several feature deformation generators are 2ⁿ*2ⁿ, 2ⁿ⁺¹*2ⁿ⁺¹, . . . , 2^{n+m}*2^{n+m}. Herein, the corresponding feature deformation generator with an output image size 2ⁿ*2ⁿ has a corresponding relationship with the first sample feature map and the second sample feature map with an image size 2ⁿ*2ⁿ. The corresponding feature deformation generator with an output image size 2ⁿ⁺¹*2ⁿ⁺¹ has a corresponding relationship with the first sample feature map and the second sample feature map with image size 2ⁿ⁺¹*2ⁿ⁺¹, and so on.

It would be appreciated that a structure between each feature deformation generator in the plurality of feature deformation generators is similar, each feature deformation generator is similar to a processing process of its input data. An example in which any of the plurality of feature deformation generators (for example, the target feature deformation generator i) is used as an example to describe a process of processing the input data. The process of processing its input data by the further feature deformation generator may refer to the process of processing the input data by the target feature deformation generator i. Wherein i is an integer from 1 to N, and N represents the number of several feature deformation generators. In one case, the number of feature deformation generators may include 7 feature deformation generators, i.e., N being 7.

Correspondingly, in an embodiment, the step S130 may specifically include: processing an input intermediate feature F_{GAN}ⁱ⁻¹ of the target feature deformation generator i based on a corresponding first sample feature map F_{scr}ⁱ, a second sample feature map F_{tgt}ⁱ and a latent variable vector w, to obtain a processed intermediate feature F_{GAN}ⁱ of the target feature deformation generator. If the target feature deformation generator i is a feature deformation generator in a non-first position, the input intermediate feature F_{GAN}ⁱ⁻¹ of the target feature deformation generator is an intermediate feature output by a previous feature deformation generator i−1 of the target feature deformation generator i, and if the target feature deformation generator i is a feature deformation generator at the first position, the input intermediate feature F_{GAN}ⁱ⁻¹ of the target feature deformation generator i is an intermediate feature F_{GAN}⁰ randomly generated by the const module.

Then, the processed prediction image Iⁱ of the target feature deformation generator i is obtained based on the processed intermediate feature F_{GAN}ⁱ of the target feature deformation generator i and the input prediction image Iⁱ⁻¹ of the target feature deformation generator i. If the target feature deformation generator i is a feature deformation generator at a non-first position, the input prediction image Iⁱ⁻¹ of the target feature deformation generator i is the prediction image output by the previous feature deformation generator i−1 of the target feature deformation generator i, and if the target feature deformation generator i is the feature deformation generator at the first position, the input prediction image Iⁱ⁻¹ of the target feature deformation generator i is the prediction image I⁰ randomly generated by the const module.

Then, if i=N, that is, the target feature deformation generator is the N-th feature deformation generator (that is, the last feature deformation generator of the generative model), the target prediction image is determined based on the processed prediction image I^{N} of the target feature deformation generator N. In an implementation, the processed prediction image I^{N} of the target feature deformation generator N at the end may be directly determined as the target prediction image.

If the target feature deformation generator i is not the feature deformation generator at the end (that is, i<N), the processed intermediate feature F_{GAN}ⁱ and the processed prediction image Iⁱ of the target feature deformation generator i are input into the next feature deformation generator i+1 of the target feature deformation generator i, so that the feature deformation generator i+1 processes the input intermediate feature F_{GAN}ⁱ of the feature deformation generator i+1 based on the corresponding first sample feature map F_{scr}ⁱ⁺¹, the second sample feature map F_{tgt}ⁱ⁺¹ and the latent variable vector w, to obtain the processed intermediate feature F_{GAN}ⁱ⁺¹ of the feature deformation generator i+1; then, based on the processed intermediate feature F_{GAN}ⁱ⁺¹ of the feature deformation generator i+1 and the input prediction image Iⁱ of the feature deformation generator i+1, the processed prediction image Iⁱ+1 of the feature deformation generator i+1 is obtained. And so on, until the processed prediction image I^{N} of the feature deformation generator N at the end is obtained, and the target prediction image is determined based on it.

It would be appreciated that the size of the input intermediate feature F_{GAN}ⁱ⁻¹ of the target feature deformation generator i and the input prediction image Iⁱ⁻¹ of the target feature deformation generator i may be smaller than the output image size corresponding to the target feature deformation generator i. For example, the corresponding output image size of the target feature deformation generator i is 2ⁿ*2ⁿ, and the dimensions of its input intermediate feature F_{GAN}ⁱ⁻¹ and input predicted image Iⁱ⁻¹ may be 2ⁿ⁻¹*2ⁿ⁻¹.

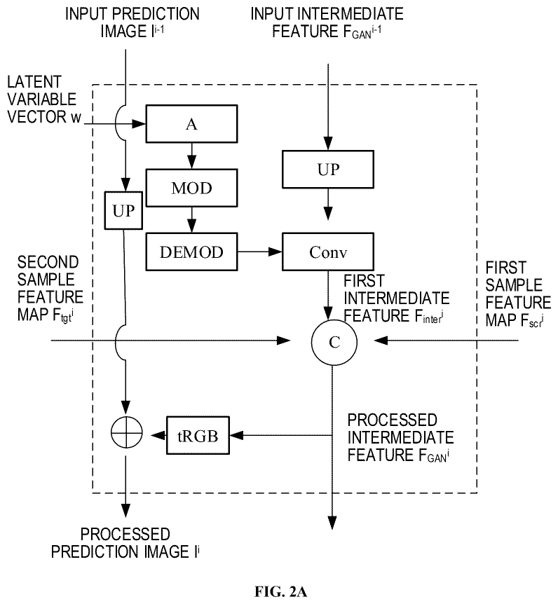

FIG. 2A is a schematic diagram of an internal structure of the target feature deformation generator i. The foregoing process of processing the input intermediate feature F_{GAN}ⁱ⁻¹ of the target feature deformation generator i may be: firstly, converting the latent variable vector w with a learnable affine conversion (as shown in FIG. 2A), to obtain a weight value of each channel in the specified convolutional network (such as ‘conv’ shown in FIG. 2A); and then sequentially perform modulation and demodulation processing on the obtained weight value with a modulation module (such as the ‘MOD’ shown in FIG. 2) and a demodulation module (as shown in FIG. 2 ‘DEMOD’) to obtain a modulated and demodulated weight value.

Then, the weight value acts on the specified convolutional network, that is, the weight value obtained after modulation and demodulation is used as the weight value of the specified convolutional network, and then the input intermediate feature F_{GAN}ⁱ⁻¹ of the target feature deformation generator after upsampling (the ‘UP’ operation shown in FIG. 2A) is input to the specified convolutional network to obtain a first intermediate feature Fᵢₙₜₑᵣⁱ, and the first intermediate feature Fᵢₙₜₑᵣⁱ includes the pose feature and the body type feature of the target object carried in the latent variable vector w. In this specification, the process of obtaining the first intermediate feature Fᵢₙₜₑᵣⁱ may be represented by the following formula (1).

$${F}_{inter}^{i} = StyleConv ( {F}_{GAN}^{i - 1} \vert w ) ; \qquad ( 1 )$$

where StyleConv represents the aforementioned conversion processing (processing of ‘A’ as shown in FIG. 2A), modulation processing (processing of ‘MOD’ as shown in FIG. 2A), demodulation processing (processing of ‘DEMOD’ as shown in FIG. 2A), and synthesis of convolution processing performed by the specified convolutional network, and w represents the aforementioned latent variable vector.

Then, the processed intermediate feature F_{GAN}ⁱ of the target feature deformation generator is determined based on the first sample feature map F_{scr}ⁱ, the second sample feature map F_{tgt}ⁱ and the first intermediate feature Fᵢₙₜₑᵣⁱ corresponding to the target feature deformation generator i. In an implementation, the first sample feature map F_{scr}ⁱ, the second sample feature map F_{tgt}ⁱ and the first intermediate feature Fᵢₙₜₑᵣⁱ corresponding to the target feature deformation generator i may be connected (as shown in the ‘C’ shown in FIG. 2A), to obtain the processed intermediate feature F_{GAN}ⁱ of the target feature deformation generator. Specifically, a predetermined Concat function may be used to connect the first sample feature map F_{scr}ⁱ, the second sample feature map F_{tgt}ⁱ, and the first intermediate feature Fᵢₙₜₑᵣⁱ. Specifically, the foregoing connection process may be represented with the following formula (2).

$${F}_{GAN}^{i} = Concat ( {F}_{scr}^{i} , {F}_{tgt}^{i} , {F}_{inter}^{i} ) ; \qquad ( 2 )$$

Next, a convolution operation is performed on the processed intermediate feature F_{GAN}ⁱ of the target feature deformation generator i, to obtain a processed intermediate feature F_{GAN}ⁱ of the target feature deformation generator after the convolution operation (the ‘tRGB’ operation shown in FIG. 2A, which represents the convolution operation). The processed intermediate feature F_{GAN}ⁱ of the target feature deformation generator after the convolution operation and the input prediction image Iⁱ⁻¹ of the target feature deformation generator i after the convolution operation are fused (represented by ‘⊕’ as shown in FIG. 2A), to obtain the processed prediction image Iⁱ of the target feature deformation generator i. Then, if the target feature deformation generator i is the last feature deformation generator (that is, i=N), the target prediction image is determined based on the processed prediction image I^{N} of the target feature deformation generator i. If the target feature deformation generator i is not the last feature deformation generator (i.e., <N), the processed intermediate feature F_{GAN}ⁱ of the target feature deformation generator i and the processed prediction image Iⁱ of the target feature deformation generator i are used as inputs to the next feature deformation generator i+1 of the target feature deformation generator i.

In a further embodiment, in order to improve the definition of the generative image and improve the authenticity of the generative image, that is, the pose and the body shape of the object in the target prediction image are more adaptive to the pose and the body shape of the target object in the target image. The const module may further randomly initialize the generated optical flow field information, and then use the randomly generated optical flow field information as the input of the deformation generative module, continuously optimize the randomly generated optical flow field information through the deformation generative module, and improve the accuracy thereof, and the final replacement model may output the optical flow field information between the two frames of images (the corresponding relationship between the corresponding pixel points between the two frames of images, for example, the correspondence between the pixel points of the sample garment (or the initial object) in the initial image and the corresponding pixel points of the target object in the target image), to deform the plurality of first sample feature maps through the optical flow field information, so that the pose features in the deformed first sample feature map are more attached to the pose features of the target object in the target image. Correspondingly, the garment replacement model may increase the prediction optical flow field information, to ensure that the pose of the object in the generative image is closer to the pose of the target object in the target image.

In a further embodiment, for the background region of the target image, in order to ensure that only garment replacement of the target object in the target image is implemented, that is, in the image generated based on the garment replacement model, only the garment worn by the target object in the target image is converted into the sample garment in the initial image, and the background region of the target image needs to be kept unchanged. In addition, considering that for the head, hand, and foot of the target object in the target image, the target object generally does not belong to the garment wearing region. In order to ensure the quality of the generative image, for this type of limb part, the corresponding limb part of the object in the generative image (the target prediction image) needs to be kept unchanged, that is, the background region in the image generated based on the garment replacement model needs to be the same as (remains unchanged) from the background region of the target image, and the head, hand and foot of the object in the generative image need to be the same as (remain unchanged) from the head, hand and foot of the target object in the target image.

Correspondingly, the background image may be extracted from the target image in advance, to obtain the background image, and the predetermined protection region is extracted from the target image to obtain the predetermined protection region image (that is, the image of the region wherein the head, hand, and foot of the target object are located). Then, after the processed prediction image output by the feature deformation generator at the end is obtained, the background image and the predetermined protection region image may be fused to the processed prediction image output by the feature deformation generator at the end, to generate a target prediction image whose background and the predetermined protection region remain unchanged from the background of the target image and the predetermined protection region, wherein the worn garment of the object is replaced with the sample garment in the initial image, and the target prediction image may include the target object after garment replacement (the sample garment after wearing deformation).

Further, in order to ensure that the target prediction image is not affected by the background region in the initial image and the predetermined protection region (the regions such as the head, hand and foot of the initial object). Correspondingly, the const module may further randomly initialize to generate the occlusion information. The randomly generated occlusion information is determined as an input of the deformation generative module, and the randomly generated occlusion information is continuously optimized through the deformation generative module, improving the accuracy thereof. The final replacement model may output occlusion information of the background region and the predetermined protection region in the plurality of first sample feature maps after the deformation corresponding to the initial image, so that in the process of fusing the background image extracted from the target image and the predetermined protection region image into the processed prediction image output by the feature deformation generator at the end, the fusion effect is ensured, the background region and the predetermined protection region in the initial image are avoided, the interference on the background region and the predetermined protection region in the target image is avoided, and the function of protecting the background region and the predetermined protection region of the target image is implemented.

Correspondingly, in an embodiment, at step S130, the target prediction image may be determined based on the plurality of first sample feature maps, the plurality of second sample feature maps, the randomly generated intermediate feature, its corresponding randomly generated prediction image, the randomly generated optical flow field information, and the randomly generated occlusion information. The randomly generated optical flow field information and the randomly generated occlusion information may both exist in an image form. The image including the occlusion information may be a binary image, and the binary image includes a pixel having a first value (for example, 0) and a pixel having a second value (for example, 1).

The deformation generative module includes a plurality of feature deformation generators arranged in series, and output image sizes corresponding to the plurality of feature deformation generators are sequentially increased. The feature deformation generator may perform an occlusion effect on the background region and the predetermined protection region in the image, and correspondingly, may be referred to as a feature warping and masking block (FWMB).

Correspondingly, at step S130, the method may specifically include: sequentially performing deformation processing and occlusion processing on the first sample feature map F_{scr}ⁱ corresponding to the target feature deformation generator I, with any target feature deformation generator i in the plurality of feature deformation generators, based on the input optical flow field information fⁱ⁻¹ of the target feature deformation generator i and the input occlusion information Mⁱ⁻¹ of the target feature deformation generator i, to obtain a deformed occluded sample feature map F̅_{src}ⁱ corresponding to the target feature deformation generator i.

FIG. 2B is a schematic diagram of an internal structure of the feature deformation generator i. Specifically, the input optical flow field information ƒⁱ⁻¹ of the target feature deformation generator i and the input occlusion information Mⁱ⁻¹ of the target feature deformation generator i are respectively upsampled to obtain the upsampled input optical flow field information ƒⁱ⁻¹ of the target feature deformation generator i and the upsampled input occlusion information Mⁱ⁻¹ of the target feature deformation generator i.

Then, the first sample feature map F_{scr}ⁱ corresponding to the target feature deformation generator i is input to the target feature deformation generator i, and the first sample feature map F_{scr}ⁱ is deformed with the upsampled input optical flow field information ƒⁱ⁻¹ of the target feature deformation generator i, that is, performing a warp operation.

Multiplying the deformed first sample feature map F_{scr}ⁱ and the upsampled input occlusion information Mⁱ⁻¹ of the target feature deformation generator i to obtain a deformed sample feature map F̅_{src}ⁱ. The occlusion information Mⁱ⁻¹ may include the predicted occlusion information of the background region for the first sample feature map F_{scr}ⁱ and the occlusion information of the predetermined protection region for the first sample feature map F_{scr}ⁱ. The deformed processed first sample feature map F_{scr}ⁱ is multiplied with the input occlusion information Mⁱ⁻¹ of the target feature deformation generator i, so that the background region and the predetermined protection region in the first sample feature map F_{scr}ⁱ may be occluded, avoiding the interference on the replacement result. The above process may be represented by the following formula (3).

$${\overline{F}}_{src}^{i} = Warp ( {F}_{scr}^{i} , {f}^{i} ) ⊙ {M}^{i - 1} ; \qquad ( 3 )$$

Then, based on the deformed occluded sample feature map

$${\overline{F}}_{src}^{i}$$

corresponding to the target feature deformation generator i, the second sample feature map F_{tgt}ⁱ and the latent variable vector w corresponding to the target feature deformation generator i, the input intermediate feature F_{GAN}ⁱ⁻¹ of the target feature deformation generator i is processed to obtain the processed intermediate feature F_{GAN}ⁱ of the target feature deformation generator. If the target feature deformation generator i is a feature deformation generator in a non-first position, the input intermediate feature F_{GAN}ⁱ⁻¹ of the target feature deformation generator is an intermediate feature output by a previous feature deformation generator i−1 of the target feature deformation generator i, and if the target feature deformation generator i is a feature deformation generator at the first position, the input intermediate feature F_{GAN}ⁱ⁻¹ of the target feature deformation generator i is an intermediate feature F_{GAN}⁰ randomly generated by the const module. For this process, reference may be made to the process of obtaining the processed intermediate feature F_{GAN}ⁱ of the target feature deformation generator as shown in FIG. 2A, and details are not described herein again. The foregoing formula (2) may be converted into the following formula (4).

$${F}_{GAN}^{i} = Concat ( {\overline{F}}_{src}^{i} , {F}_{tgt}^{i} , {F}_{inter}^{i} ) ; \qquad ( 4 )$$

Then, the processed prediction image Iⁱ of the target feature deformation generator i is obtained based on the processed intermediate feature F_{GAN}ⁱ of the target feature deformation generator i and the input prediction image Iⁱ⁻¹ of the target feature deformation generator. The input prediction image Iⁱ of the target feature deformation generator i is the prediction image Iⁱ⁻¹ output by the previous feature deformation generator i−1 of the target feature deformation generator i. If the target feature deformation generator i is the feature deformation generator at the first position, the input prediction image Iⁱ of the target feature deformation generator i is the prediction image I⁰ randomly generated by the const module.

Specifically, as shown in FIG. 2B, the input prediction image Iⁱ⁻¹ of the target feature deformation generator after upsampling (the ‘UP’ operation as shown in the figure) is fused with the processed intermediate feature F_{GAN}ⁱ of the target feature deformation generator i after the convolution operation (for example, referred to as the first convolution operation, including the to-be-trained model parameter), and the ‘⊕’ operation shown in FIG. 2B is performed to obtain the processed prediction image Iⁱ of the target feature deformation generator i.

The processed prediction image Iⁱ may be represented by the following formula (5).

$${I}^{i} = tRGB ( {F}_{GAN}^{i} ) + UP ( {I}^{i - 1} ) ; \qquad ( 5 )$$

where tRGB(·) represents a first convolution operation, and UP(·) represents upsampling.

In addition, the processed optical flow field information ƒⁱ of the target feature deformation generator i is obtained based on the processed intermediate feature F_{GAN}ⁱ of the target feature deformation generator i and the input optical flow field information ƒⁱ⁻¹ of the target feature deformation generator. Based on the processed intermediate feature F_{GAN}ⁱ of the target feature deformation generator i and the input occlusion information Mⁱ⁻¹ of the target feature deformation generator, the processed occlusion information Mi of the target feature deformation generator i is obtained.

Specifically, as shown in FIG. 2B, the input optical flow field information fⁱ⁻¹ of the target feature deformation generator after upsampling (the ‘UP’ operation as shown in the figure) is fused with the processed intermediate feature F_{GAN}ⁱ of the target feature deformation generator i after the convolution operation (referred to as the second convolution operation, including the to-be-trained model parameter), and as shown in FIG. 2B, ‘⊕’ operation is performed to obtain the processed optical flow field information ƒⁱ of the target feature deformation generator i. The input occlusion information Mⁱ of the target feature deformation generator after up-sampling (‘UP’ operation as shown in Figure) and the processed intermediate feature F_{GAN}ⁱ of the target feature deformation generator i after convolution operation (referred as the third convolution operation, including the model parameters to be trained) are fused, and the ‘⊕’ operation as shown in FIG. 2B is shown. The processed occlusion information Mⁱ of the target feature deformation generator i is obtained.

The processed optical flow field information fi may be expressed by formula (6), and the processed occlusion information Mⁱ may be expressed by formula (7).

$${f}^{i} = tXY ( {F}_{GAN}^{i} ) + UP ( {f}^{i - 1} ) ; \qquad ( 6 )$$

$${M}^{i} = tMask ( {F}_{GAN}^{i} ) + UP ( {M}^{i - 1} ) ; \qquad ( 7 )$$

where tXY(·) represents a second convolution operation; and tMask(·) represents a third convolution operation.

If the target feature deformation generator i is the non-first feature deformation generator, the input optical flow field information ƒⁱ⁻¹ of the target feature deformation generator i and the input occlusion information Mⁱ⁻¹ of the target feature deformation generator i are the optical flow field information ƒⁱ⁻¹ and the occlusion information Mⁱ⁻¹ output by the previous feature deformation generator i−1 of the target feature deformation generator I, respectively. If the target feature deformation generator i is the first feature deformation generator, the input optical flow field information ƒⁱ⁻¹ of the target feature deformation generator i and the input occlusion information Mⁱ⁻¹ of the target feature deformation generator are respectively the optical flow field information ƒ⁰ and occlusion information M° randomly generated by the const module.

Then, if the target feature deformation generator i is the feature deformation generator at the end (that is, i=N, is the last feature deformation generator of the generative model), the target prediction image is determined based on the processed prediction image I^{N} of the target feature deformation generator i.

If the target feature deformation generator i is not the feature deformation generator at the end, the processed intermediate feature F_{GAN}ⁱ, the processed prediction image Iⁱ, the processed optical flow field information fi, and the processed occlusion information Mⁱ of the target feature deformation generator i are input into the next feature deformation generator i+1 of the target feature deformation generator i, so that the feature deformation generator i+1 processes the input intermediate feature F_{GAN}ⁱ, the input prediction image Iⁱ, the input optical flow field information fi, and the input occlusion information Mⁱ based on the corresponding first sample feature map and the second sample feature map and the latent variable vector w, that is, the processed intermediate feature F_{GAN}ⁱ, the processed prediction image Iⁱ, the processed optical flow field information fi, and the processed occlusion information Mⁱ of the input intermediate feature F_{GAN}ⁱ, the input prediction image Iⁱ, the input optical flow field information fi, and the input occlusion information Mi, so that the updated input intermediate feature F_{GAN}ⁱ, the input prediction image Iⁱ, the input optical flow field information fi, and the input occlusion information Mⁱ may better and comprehensively fuse the pose feature and the body shape feature of the target object in the second sample feature map and the garment information of the sample garment in the first sample feature map to obtain the deformed sample garment more consistent with the pose feature and the body shape feature of the target object, that is, obtain an image containing the pose and body shape of the target object and the object (target object) wearing the sample garment. By analogy, until the processed prediction image IN of the feature deformation generator N at the end is obtained, the target prediction image I^{N} is determined based on this.

In an embodiment, in order to ensure that the image of the background region and the predetermined protection region in the target image is not changed, as shown in FIG. 1B, the generative model may further include a fusion device. The process of obtaining the target prediction image I^{N} based on the processed prediction image I^{N} of the feature deformation generator N at the end may be: fuse, with the fusion device, the background image (referred to as the target background image I_{tgt}^{BG}) including the background region of the target image, the protection region image including the target image predetermined protection region (referred to as the target protection region image I_{tgt}^{PT}) and the occlusion information M^{N} output by the feature deformation generator at the end to obtain the target prediction image.

Specifically, the occlusion information M^{N} output by the feature deformation generator at the end includes occlusion information M_{BG} for the background region and occlusion information MPT for the predetermined protection region. The foregoing process of obtaining the target prediction image by fusing may be: based on the occlusion information MPT for the predetermined protection region, the target protection region image I_{tgt}^{PT}, and the processed prediction image I^{N} of the feature deformation generator N at the end, fusing to obtain the intermediate prediction image Iᵢₙₜₑᵣ; and fusing to obtain the target prediction image based on the target background image I_{tgt}^{BG}, the occlusion information M_{BG} and the intermediate prediction image Iᵢₙₜₑᵣ for the background region.

Specifically, the process of obtaining the intermediate prediction image Iᵢₙₜₑᵣ may be represented by the following formula (8).

$${I}_{inter} = {I}_{tgt}^{PT} ⊙ ( 1 - {M}_{PT} ) + {I}^{N} ⊙ {M}_{PT} ; \qquad ( 8 )$$

$$\hat{I} = {I}_{tgt}^{BG} ( 1 - {M}_{BG} ) + {I}_{inter} {M}_{BG} ; \qquad ( 9 )$$

After the target prediction image is obtained in the foregoing manner, at step S140, a current prediction loss is determined based on the target prediction image and the target image. In this step, the target image is determined as a label image. Correspondingly, a reconstruction loss between the target prediction image and the target image may be determined according to the target prediction image and the target image based on a predetermined loss function, wherein the predetermined loss function may be a L1 loss function.

Specifically, the reconstruction loss may be represented by the following formula (10).

$${L}_{rec} = {‖ \hat{I} - {I}_{tqt} ‖}_{1} ; \qquad ( 10 )$$

where L_{rec} represents the reconstruction loss, I_{tgt} represents a target image, and ∥Î-I_{tgt}∥₁ represents a L1 loss value between the target prediction image and the target image.

In an implementation, the reconstruction loss may be directly determined as the current prediction loss. In still a further implementation, the garment replacement model may further include a discriminative model, and correspondingly, to ensure the garment replacement capability of the model, adversarial loss may be further constructed. The current prediction loss is determined based on the reconstructive loss and the adversarial loss of the advent. For example, the sum of the reconstruction loss and the adversarial loss may be determined as the current prediction loss.

Herein, the process of constructing the adversarial loss may be: inputting the target prediction image into a discriminative model for determining whether the input image is a real image, obtaining a prediction probability that the target predetermined image determined by the discriminative model is a real image, and constructing an adversarial loss based on the prediction probability. Specifically, the adversarial loss may be represented with the following formula (11).

$${L}_{adv} = {E}_{\hat{I}} log ( 1 + exp ( - D ( \hat{I} ) ) ) ; \qquad ( 11 )$$

where L_{adv} represents adversarial loss, and D(Î) represents a prediction probability that the target predetermined image determined by the discriminative model is a real image.

After the current prediction loss is determined, then at step S150, a model parameter of the garment replacement model is adjusted based on the current prediction loss. In this step, the model parameter of the garment replacement model (that is, the generative model) is adjusted to minimize the current prediction loss, that is, the model parameter of the generative model of the garment replacement model is adjusted with an aim to minimize the reconstruction loss, and maximize the prediction probability that the target predetermined image discriminated by the discriminant model is the real image (that is, the discriminative model determines that the target predetermined image is the real image).

In an implementation, in a case that the garment replacement model further includes a discriminative model, the model parameters of the discriminative model and the model parameters of the generative model may be updated respectively in a manner of alternately updating the model parameters of the discriminative model and the model parameters of the generative model. Specifically, in the case of updating the model parameters of the generative model, the model parameters of the discriminative model are fixed, and in the case of updating the model parameters of the discriminative model, the model parameters of the generative model are fixed. In the case that the model parameter of the generative model is updated, the reconstruction loss may be minimized, and the model parameter of the discriminative model of the garment model is adjusted based on the prediction probability that the target predetermined image discriminated by the discriminative model is the real image (that is, the discriminative model discriminates that the target predetermined image is not a real image). In this way, it forms a confrontation with the generative model to improve the authenticity of the image generated by the generative model, that is, to improve the garment replacement effect.

Recall that the execution process of steps S110-S150 is described by taking a pair of sample image pairs (i.e., a pair of initial images and a target image) as a sample. In a further embodiment, the foregoing steps S110 to S140 may also be performed on a batch of samples, that is, a plurality of pairs of sample images (a plurality of pairs of initial images and target images), to obtain a target prediction image corresponding to each pair of sample images. Then, a current prediction loss is determined based on the target prediction image corresponding to each pair of sample images and the target image in each pair of sample image pairs at step S150, to minimize the current prediction loss as the target, and train the generative model. In this embodiment, the current prediction loss is determined for a batch of samples, and then the model parameters of the generative model are adjusted, so that the number of model parameter adjustments to the generative model may be reduced, and the implementation of the training process is easier.

The garment replacement model is trained in the foregoing manner, until the garment replacement model reaches a predetermined convergence condition, to obtain a trained garment replacement model, wherein the garment replacement model is configured to provide a garment replacement service. The predetermined convergence condition may include, but is not limited to: a current prediction loss of the garment model is lower than a predetermined threshold, or a model parameter iteration adjustment number of the generative model reaches a predetermined number threshold, or the generative model and the discriminative model reach a predetermined balance condition.

In an implementation, after the garment replacement model is trained, the garment replacement model may also be tested, each test image pair used in the test process may include a pair of test initial images and test target images, and the pair of test initial images and the test target images may include wearing different objects and being in different poses.

In the above process, the limb segmentation information including the body shape and pose information is added as the input of the garment replacement model, so that the garment replacement model learns the ability to extract the body shape and pose information of the object in the image, and makes the pose and body shape of the object (garment) in the generative image more conform to the pose and body shape of the object to be garment-replaced. In addition, a plurality of feature deformation generators with increasing size of corresponding output images are set serially, which may ensure that the garment replacement model generates images with higher resolution, and ensure the clarity of the generative images and the clarity of the texture and color of the replaced garment.

Moreover, the garment replacement model adds the prediction optical flow field information and the occlusion information, so that the pose and the body shape of the object in the generative image are more accurate, the deformation of the garment is more accurate, the target image is more attached to the predetermined protection region and the background region, the garment replacement effect is improved, and the effect that the generative image object is the person to be garment-replaced is ensured.

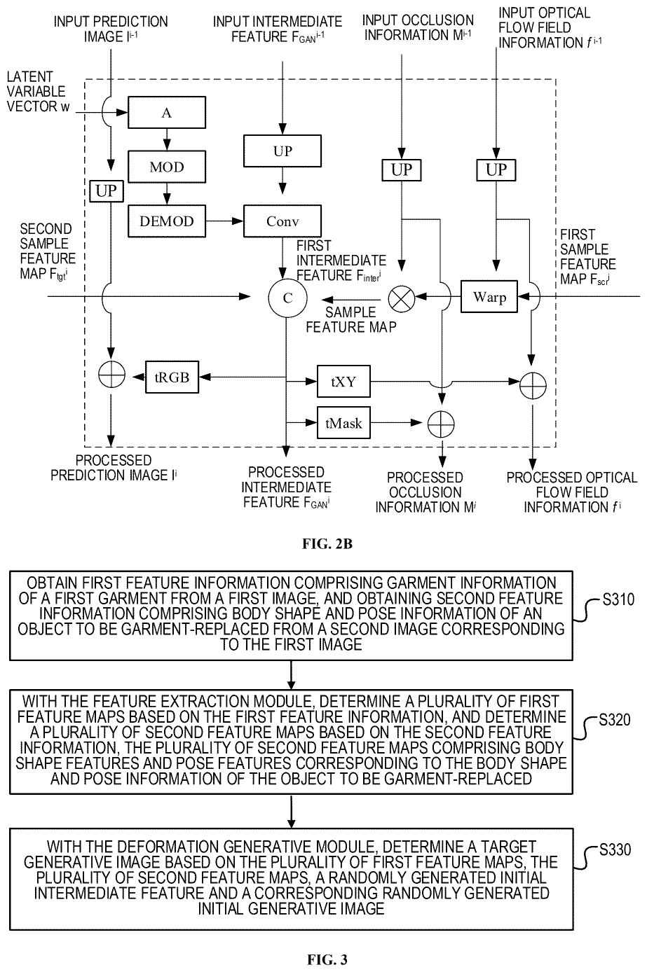

Then, after the trained model changing model is obtained, that is, entering the second stage, virtual garment replacement may be performed based on the garment replacement model. FIG. 3 is a schematic flowchart of a method for virtual garment replacing based on a garment replacement model according to an embodiment of the present specification. The method may be implemented by a target program. The target program may be installed in an electronic device, and the electronic device may be implemented by any apparatus, device, platform, device cluster, or the like having computing and processing capabilities. As shown in FIG. 3, the garment replacement model includes a generative model that includes a feature extraction module and a deformation generative module, wherein the method includes:

At step S310, obtaining first feature information including garment information of a first garment from a first image, and obtaining second feature information including body shape and pose information of an object to be garment-replaced from a second image corresponding to the first image. The object to be garment-replaced is, for example, a person to be garment-replaced.

In an implementation, the first image includes the first garment, and the first feature information including the garment information of the first garment may be extracted from the first image, wherein the extraction process of the first feature information may refer to the extraction process of the first sample feature information in the foregoing training method embodiment of the replacement model, and details are not described herein again.

In an embodiment, the first image includes a first object wearing the first garment, the first feature information includes first limb region information of the first object, first limb key point information, first limb pose information and first limb segmentation information, the first limb region information includes garment information of the first garment, and the first limb segmentation information includes body shape and pose information of the first object.

The second image includes an object to be garment-replaced. In one case, the object to be garment-replaced and the first object may be different real objects, and they are different in wearing and different poses. In a further case, the object to be garment-replaced and the first object may be the same real object, and they wear the same (or different), be in different poses, and the like.

Correspondingly, the second feature information includes: second limb region information, second limb key point information, second limb pose information and second limb segmentation information of the object to be garment-replaced, the second limb segmentation information including the body shape and pose information of the object to be garment-replaced, and the second limb region information including a predetermined protection region of the object to be garment-replaced belonging to a non-garment wearing region.

Herein, for an extraction manner of the first limb region information, the first limb key point information, the first limb pose information, and the first limb segmentation information of the first object in the first image, and an extraction manner of the second limb region information, the second limb key point information, the second limb pose information, and the second limb segmentation information of the object to be garment-replaced in the second image, reference may be made to the initial limb region information, the initial limb key point information, the initial limb pose information, and the extraction manner of the initial limb segmentation information in the foregoing training method embodiment of the replacement model, and details are not described herein again.

After the first feature information and the second feature information are obtained, then at step S320, with the feature extraction module, a plurality of first feature maps are determined based on the first feature information, and a plurality of second feature maps are determined based on the second feature information, the plurality of second feature maps including body shape features and pose features corresponding to the body shape and pose information of the object to be garment-replaced.

In an embodiment, the feature extraction module may include a first feature extractor and a second feature extractor, the first feature extractor and the second feature extractor are set in parallel; at step S320, the process of determining the plurality of first feature maps based on the first feature information includes: processing the first feature information with the first feature extractor to obtain the plurality of first feature maps, wherein sizes of the plurality of first feature maps are different; and the process of determining the plurality of second feature maps based on the second feature information includes: processing the second feature information with the second feature extractor to obtain the plurality of second feature maps, wherein sizes of the plurality of second feature maps are different.

In one case, the plurality of first feature maps may include feature maps of a plurality of image sizes, and the plurality of first feature maps may include at least a garment feature (for example, a color, a texture, a contour, and the like) of the first garment, and may further include a limb feature (for example, a pose and a body shape) of the first object. In fact, for any of the first feature maps, it is output by a certain layer or a certain sub-extraction module (for example, each sub-extractor of the first feature extractor) in the feature extraction module, and correspondingly, any of the first feature maps may include at least one of the foregoing garment features (e.g., color, texture, contour, etc.) of the first garment and/or limb features (e.g., pose and body shape) of the first object.

Several second feature maps may include features of a variety of image sizes. The plurality of second feature maps each includes a body shape feature corresponding to the body shape and pose information of the object to be garment-replaced, and may further include a pose feature representing the pose information of the target object. In the case that the second feature map further includes the second limb key point information, and the second limb pose information, the plurality of second feature maps may further include a pose feature that may better represent the pose information of the object to be garment-replaced. In fact, for any of the second feature maps, it is output by a certain layer in the feature extraction module or a certain sub-extraction module (for example, each sub-extractor of the second feature extractor). Correspondingly, any of the second feature maps may include at least one of the foregoing body type features and pose features. The second limb region information may include limb features (e.g., features of the head, hand, and foot) of the non-garment covering region of the subject to be garment-replaced.

Then, at step S330, with the deformation generative module, a target generative image is determined based on the plurality of first feature maps, the plurality of second feature maps, a randomly generated initial intermediate feature and a corresponding randomly generated initial generative image, the target generative image including an object to be garment-replaced wearing a deformed first garment, and the deformed first garment conforming to the body shape feature and pose feature of the object to be garment-replaced.

The initial intermediate feature and the corresponding initial generative image may be a constant input module included in the generative model, that is, the const module is randomly generated to assist in generating the target generative image. In this step, the plurality of first feature maps, the plurality of second feature maps, the initial intermediate features, and the corresponding initial generative images are input to the deformation generative module, so that the deformation generative module processes the initial intermediate features and their corresponding initial generative images with the plurality of first feature maps and the plurality of second feature maps, and then obtains the target generative images with the processed intermediate features and the processed generative images, so as to deform the first garment (that is, the limb of the first object) based on the body shape features and the pose features of the object to be garment-replaced, to obtain a deformed first garment that conform to the body shape features and the pose features of the object to be garment-replaced. Thus, a target generative image including the object to be garment-replaced of the first garment after wearing the deformation is generated, to implement garment replacement of the object to be garment-replaced, that is, the first garment is migrated to the body of the object to be garment-replaced.

In an embodiment, in order to better improve the garment replacement capability of the garment replacement model and ensure the garment replacement effect, the generative model further includes: a latent variable extractor, the feature extraction module determining a target feature extraction result further based on the second feature information, wherein the method further includes:
extracting, from the target feature extraction result based on the latent variable extractor, a body shape and pose vector representing a body shape feature and a pose feature of the object to be garment-replaced; correspondingly, at step S330, the method may specifically include: determining the target generative image based on the plurality of first feature maps, the plurality of second feature maps, the body shape and pose vector, the initial intermediate feature and the initial generative image.

Herein, the target feature extraction result may be a result output by a last layer of sub-extractor in the second feature extractor (for example, a result in a form of a feature map or a result in a form of a vector). Specifically, the target program may process the initial intermediate feature and the initial generative image with the plurality of first feature maps, the plurality of second feature maps, and the body shape and pose vector, and further obtain the target generative image with the processed intermediate feature and the processed generative image, so that the object pose and the body shape in the target generative image are more attached to the pose and the body shape of the object to be garment-replaced in the second image, thereby improving the garment replacement effect.

In an embodiment, to generate an image with a higher definition, the deformation generative module may include a plurality of feature deformation generators set in series, and output image sizes corresponding to the plurality of feature deformation generators are sequentially increased, the plurality of first feature maps and the plurality of second feature maps include: a first feature map and a second feature map respectively corresponding to each of the feature deformation generators.

At step S330, the method may include the following step 11-13. At step 11, a current intermediate feature is processed with any target feature deformation generator among the plurality of feature deformation generators, based on a first feature map and a second feature map corresponding to the feature deformation generator, and the body shape and pose vector, to obtain an updated intermediate feature, the current intermediate feature being an intermediate feature output by a previous feature deformation generator of the target feature deformation generator, or the initial intermediate feature.

At step 12, an updated generative image is obtained based on the updated intermediate feature and the current generative image, to obtain the target generative image, wherein the current generative image is a generative image output by a previous feature deformation generator of the target feature deformation generator, or the initial generative image.

At step 13, in response to the target feature deformation generator being a feature deformation generator at the end, the target generative image is determined based on the obtained updated generative image.

It would be appreciated that a structure between each feature deformation generator in the plurality of feature deformation generators is similar, each feature deformation generator is similar to a processing process of input data. Taking any of the plurality of feature deformation generators (for example, the target feature deformation generator i) as an example to describe a process of processing the input data. The process of processing the input data by the further feature deformation generator may refer to the process of processing the input data by the target feature deformation generator i. Wherein i is an integer from 1 to N, and N represents the number of several feature deformation generators. In one case, the number of feature deformation generators may include 7 feature deformation generators, i.e., N being 7.

Specifically, the current intermediate feature of the target feature deformation generator i is processed based on the first feature map, the second feature map, and the body shape and pose vector corresponding to the target feature deformation generator i, to obtain the updated intermediate feature of the target feature deformation generator i. If the target feature deformation generator i is a feature deformation generator at a non-first position, the current intermediate feature is an intermediate feature output by a previous feature deformation generator i−1 of the target feature deformation generator i. If the target feature deformation generator i is a feature deformation generator at a first position, the current intermediate feature is an initial intermediate feature randomly generated by the const module.

Then, an updated generative image of the target feature deformation generator i is obtained based on the updated intermediate feature of the target feature deformation generator i and the current generative image of the target feature deformation generator i. Herein, if the target feature deformation generator i is a feature deformation generator at a non-first position, the current generative image is a generative image output by a previous feature deformation generator i−1 of the target feature deformation generator i. If the target feature deformation generator i is a feature deformation generator at the first position, the current generative image is an initial generative image generated randomly by the const module.

Then, if the target feature deformation generator i is the feature deformation generator at the end (that is, i=N, and that is, the last feature deformation generator of the generative model), the target generative image is determined based on the updated generative image of the target feature deformation generator i. In an implementation, the updated generative image of the target feature deformation generator N may be directly generated as the target generative image.

If the target feature deformation generator i (i<N) is not the feature deformation generator at the end, the updated intermediate feature and the updated generative image of the target feature deformation generator i are input, and the next feature deformation generator i+1 of the target feature deformation generator i is input, so that the feature deformation generator i+1 processes the current intermediate feature of the feature deformation generator i+1 (that is, the updated intermediate feature of the target feature deformation generator i) based on the corresponding first feature map, the second feature map, and the body shape and pose vector, to obtain an updated intermediate feature of the feature deformation generator i+1. Then, based on the updated intermediate feature of the feature deformation generator i+1 and the current generative image of the feature deformation generator i+1 (that is, the updated generative image of the target feature deformation generator i), the updated generative image of the feature deformation generator i+1 is obtained. By analogy, until the updated generative image of the feature deformation generator N at the end is obtained, the target prediction image is determined based on the updated generative image.

It would be appreciated that the current intermediate feature of the target feature deformation generator i and the size of the currently generative image may be smaller than the output image size corresponding to the target feature deformation generator i, for example, the output image size corresponding to the target feature deformation generator i is 2ⁿ*2ⁿ, the size of the current intermediate feature and the current generative image may be 2ⁿ⁻¹*2ⁿ⁻¹, and the image size of the first feature map and the second feature map corresponding to the target feature deformation generator i may be 2ⁿ*2ⁿ.

Based on the internal structure of the target feature deformation generator i shown in FIG. 2A, the foregoing process of processing the current intermediate feature of the target feature deformation generator i may be: firstly, converting the body shape and pose vector with a learnable affine conversion (as shown in FIG. 2A), to obtain a weight value of each channel in the specified convolution network (such as ‘conv’ shown in FIG. 2A), and then sequentially perform, with a modulation module (such as ‘MOD’ shown in FIG. 2) and a demodulation module (as shown in FIG. 2 ‘DEMOD’), modulation and demodulation processing on the obtained weight value to obtain a weight value after modulation and demodulation processing.

Then, the weight value acts on the specified convolutional network, that is, the weight value obtained after modulation and demodulation is used as the weight value of the specified convolutional network, and then the up-sampled current intermediate feature is input into the specified convolutional network to obtain the second intermediate feature, wherein the second intermediate feature includes the pose feature and the body shape feature of the object to be garment-replaced carried in the body shape and pose vector.

Then, the updated intermediate feature of the target feature deformation generator is determined based on the first feature map, the second feature map, and the second intermediate feature corresponding to the target feature deformation generator i. In an implementation, the first feature map, the second feature map, and the second intermediate feature corresponding to the target feature deformation generator i may be connected to obtain the updated intermediate feature of the target feature deformation generator. Specifically, a predetermined Concat function may be used to connect the first feature map, the second feature map F, and the second intermediate feature. For a specific connection process, reference may be made to the connection process of the first sample feature map, the second sample feature map, and the first intermediate feature corresponding to the target feature deformation generator i in the foregoing embodiment, and details are not described herein again.

Then, the foregoing process of obtaining an updated image may include: performing a convolution operation on the updated intermediate feature of the target feature deformation generator i to obtain an updated intermediate feature after the convolution operation, and fusing the updated intermediate feature after the convolution operation and the current generative image of the upsampled target feature deformation generator i to obtain an updated image of the target feature deformation generator i.

Then, if the target feature deformation generator i is the last feature deformation generator (that is, the feature deformation generator N), the target generative image is determined based on the updated generative image of the target feature deformation generator N. If the target feature deformation generator i is not the last feature deformation generator, the updated intermediate feature of the target feature deformation generator i and the updated generative image of the target feature deformation generator i are used as inputs to the next feature deformation generator i+1 of the target feature deformation generator i.

In a further embodiment, in order to improve the clarity of the generative image and improve the authenticity of the generative image, that is, the pose and the body shape of the object in the target prediction image are more adaptive to the pose and the body shape of the target object in the target image. The const module may also randomly initialize the generated optical flow field information (referred to as initial optical flow field information), then use the randomly generated optical flow field information as an input of the deformation generative module, continuously optimize the initial optical flow field information through the deformation generative module, and improve the accuracy thereof, and the final replacement model may output optical flow field information between the first image and the second image, wherein the optical flow field information may include a correspondence between the first garment (or each pixel in the first image) in the first image and the object to be garment-replaced (each pixel in the second image) in the second image.

In still a further embodiment, for the background region of the second image, in order to ensure that only the garment replacement of the object to be garment-replaced in the second image is implemented, that is, in the image generated based on the garment replacement model, only the garment worn in the object to be garment-replaced in the second image is converted into the first garment in the first image, and the background region of the target image needs to be kept unchanged. In addition, considering that for the head, hand and foot of the object to be garment-replaced in the second image, the head, hand, and foot of the object to be garment-replaced generally do not belong to the garment wearing region, in order to ensure the quality of the generative image, for this type of body part, the corresponding limb part of the object in the generative image (the target generation image) needs to be generated, and remains unchanged relative to the second image, that is, the background region in the image generated based on the garment replacement model needs to be the same as (remains unchanged) from the background region of the target image, and the head, hand and foot of the object in the generative image need to be the same as (remain unchanged) from the head, hand and foot of the target object in the target image.

Correspondingly, the background image may be extracted from the second image in advance, to obtain the background image, and the predetermined protection region is extracted from the second image to obtain the predetermined protection region image (that is, the image of the region wherein the head, hand, and foot of the object to be garment-replaced are located). Then, after the updated generative image output by the feature deformation generator at the end is obtained, the background image and the predetermined protection region image may be fused to the updated generative image output by the feature deformation generator at the end, to generate the target generative image with the background and the predetermined protection region unchanged from the background of the second image and the predetermined protection region, wherein the worn garment of the object is replaced with the first garment in the first image, and the target generative image may be generated to include the object to be garment-replaced of the first garment after being worn.

In order to ensure that the target generative image is not affected by the background region in the first image and the predetermined protection region (the regions such as the head, hand and foot of the first object). Correspondingly, the const module may further randomly initialize to generate occlusion information (referred to as initial occlusion information), use the initial occlusion information as an input of the deformation generative module, continuously optimize the initial occlusion information through the deformation generative module, improve the accuracy thereof, and finally output the occlusion information of the background region and the predetermined protection region in the plurality of first feature maps corresponding to the first image. Thus, the garment replacement model has the capability of occluding the background region feature and the predetermined protection region feature in the plurality of first feature maps corresponding to the first image, so as to ensure the fusion effect in the process of fusing the background image and the predetermined protection region image extracted from the second image into the updated image generated by the feature deformation generator at the end. The background region and the predetermined protection region in the first image are prevented from interfering with the background region and the predetermined protection region in the second image, so as to protect the background region and the predetermined protection region of the second image. Both the initial optical flow field information and the initial occlusion information may exist in an image form. The image including the occlusion information may be a binary image including a pixel having a first value (e.g., 0) and a pixel having a second value (e.g., 1).

Correspondingly, at step 11, the following step 111-113 may be included. At step 111, a deformation occluding operation is performed on a first feature map corresponding to the target feature deformation generator with current deformation occlusion information to obtain a first feature map after deformation occlusion, the current deformation occlusion information being deformation occlusion information output by a previous feature deformation generator of the target feature deformation generator, or initial deformation occlusion information obtained by initialization. Herein, the current deformation occlusion information includes current optical flow field information and current occlusion information, the current occlusion information including predicted occlusion information for protecting a background region of the second image and predicted occlusion information for protecting a predetermined protection region in the second image, the current optical flow field information at least including a predicted correspondence between a first garment in the first image and an object to be garment-replaced in the second image. In an implementation, when the first image includes the object wearing the garment, the correspondence may further include a correspondence between the object in the first image and the object to be garment-replaced in the second image in the pose.

At step 112, the current intermediate feature is processed with the body shape and pose vector to obtain a first intermediate feature.

At step 113, an updated intermediate feature of the target feature deformation generator is generated based on the first feature map after deformation occlusion, the second feature map corresponding to the target feature deformation generator, and the first intermediate feature.

In this implementation, the target feature deformation generator i is used to perform deformation processing on the first feature map corresponding to the target feature deformation generator i based on the current optical flow field information sampled on the target feature deformation generator i, that is, perform a warp operation. Then, the deformed first feature map and the up-sampled current occlusion information of the target feature deformation generator i are multiplied to obtain the deformed first feature map. The occlusion information Mⁱ may include the predicted occlusion information for the background region of the first feature map and the occlusion information of the predetermined protection region for the first feature map, and the first feature map after the deformation processing and the current occlusion information Mⁱ of the target feature deformation generator i are multiplied (that is, the occlusion information for the background region of the first feature map and the occlusion information of the predetermined protection region for the first feature map are respectively multiplied), so that the background region and the predetermined protection region in the first feature map may be blocked, and the interference on the replacement result is avoided.

Then, the current intermediate feature of the target feature deformation generator i is processed based on the deformed occlusion first feature map corresponding to the target feature deformation generator i, the second feature map corresponding to the target feature deformation generator i, and the body shape and pose vector, to obtain the updated intermediate feature of the target feature deformation generator. If the target feature deformation generator i is a feature deformation generator at a non-first position, a current intermediate feature of the target feature deformation generator i is an intermediate feature output by a previous feature deformation generator i−1 of the target feature deformation generator i, and if the target feature deformation generator i is a feature deformation generator at a first position, a current intermediate feature of the target feature deformation generator i is an initial intermediate feature. For the process of processing the current intermediate feature of the target feature deformation generator i, reference may be made to the process of obtaining the processed intermediate feature F_{GAN}ⁱ of the target feature deformation generator as shown in FIG. 2A, and details are not described herein again.

Then, an updated generative image of the target feature deformation generator is obtained with the updated intermediate feature of the target feature deformation generator and the current generative image of the target feature deformation generator i. For the process of obtaining the updated generative image of the target feature deformation generator, reference may be made to the process of obtaining the processed prediction image of the target feature deformation generator in the foregoing embodiment, and details are not described herein again.

In addition, it is also necessary to determine, based on the updated intermediate feature and the current deformation occlusion information (that is, the current optical flow field information and the current occlusion information) of the target feature deformation generator i, updated deformation occlusion information of the target feature deformation generator (that is, updated optical flow field information and updated occlusion information). Specifically, in an embodiment, the process of determining the updated deformation occlusion information of the target feature deformation generator may include: fusing the upsampled current deformation occlusion information and the updated intermediate feature after the convolution operation, to determine updated deformation occlusion information.

The process of determining the updated deformation occlusion information, that is, determining the updated optical flow field information and the updated occlusion information, may refer to the process of determining the processed optical flow field information and the processed occlusion information based on the structure shown in FIG. 2B, and details are not described herein again.

In an embodiment, in order to ensure that the image of the background region and the predetermined protection region in the target image is not changed, the garment replacement effect is ensured, and the generative model may further include: a fuser; correspondingly, the process of determining the target generative image based on the updated generative image may include: fusing, with the fuser, to obtain the target generative image based on the updated generative image, a background image including the background region of the second image, a protection region image including the determined protection region and target occlusion information output by a feature deformation generator at the end. For the process of obtaining the target generative image by fusion, reference may be made to the foregoing embodiments to fuse to obtain the target prediction image process, and details are not described herein again.

In this embodiment, the limb segmentation information including the body shape and pose information is added as the input of the garment replacement model, so that the garment pose information of the object to be garment-replaced in the second image may be extracted by the garment replacement model, and then the pose and the body shape of the object (the garment) are generated to be more attached to the pose and the body shape of the object to be garment-replaced.

The feature deformation generator with a plurality of corresponding output image sizes set in series may ensure that the garment replacement model generates an image with higher resolution, thereby ensuring the clarity of the generative image and the texture and color definition of the garment replacement. The garment replacement model adds the prediction optical flow field information and the occlusion information, so that the pose and the body shape of the object in the generative image are more accurate, the deformation of the garment is more accurate, the target image is more attached to the predetermined protection region and the background region, the garment replacement effect is improved, and the effect that the generative image object is the person to be garment-replaced is ensured.

The foregoing describes specific embodiments of the present specification, and other embodiments are within the scope of the appended claims. In some cases, the acts or steps recited in the claims may be performed in a different order than in the embodiments, and the desired results may still be implemented. Additionally, the processes depicted in the figures are not necessarily to achieve the desired results in a particular order or sequential order shown. In certain embodiments, multitasking and parallel processing are also possible, or may be advantageous.

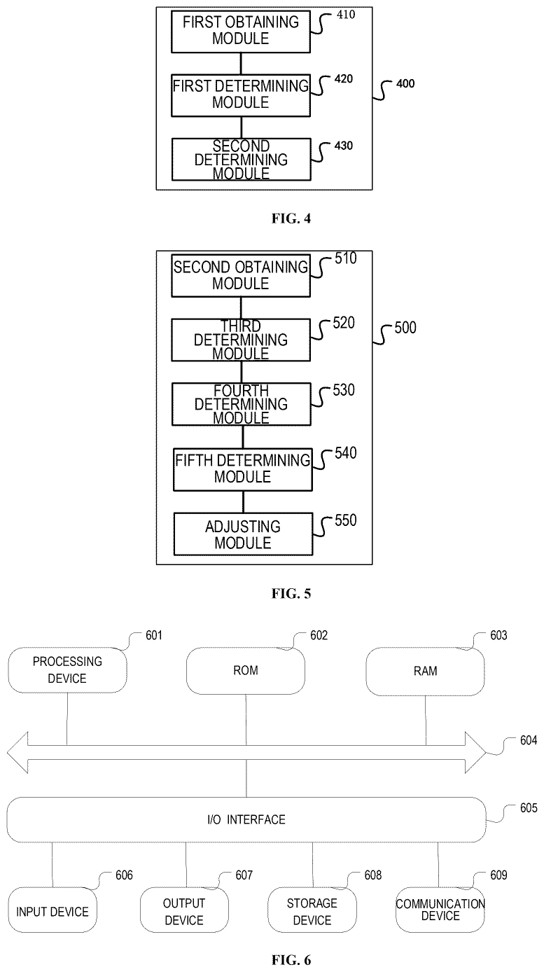

Corresponding to the foregoing method embodiments, an embodiment of the present specification provides an apparatus 400 for virtual garment replacing based on a garment replacement model, the schematic block diagram of which is shown in FIG. 4, the garment replacement model includes a generative model that includes a feature extraction module and a deformation generative module; and the apparatus includes: a first obtaining module 410 configured to obtain first feature information including garment information of a first garment from a first image, and obtaining second feature information including body shape and pose information of an object to be garment-replaced from a second image corresponding to the first image; a first determining module 420 configured to, with the feature extraction module, determine a plurality of first feature maps based on the first feature information, and determining a plurality of second feature maps based on the second feature information, the plurality of second feature maps including body shape features and pose features corresponding to the body shape and pose information of the object to be garment-replaced; and a second determining module 430 configured to, with the deformation generative module, determine a target generative image based on the plurality of first feature maps, the plurality of second feature maps, a randomly generated initial intermediate feature and a corresponding randomly generated initial generative image, the target generative image including an object to be garment-replaced wearing a deformed first garment, and the deformed first garment conforming to the body shape feature and pose feature of the object to be garment-replaced.

In an optional implementation, the first image includes a first object wearing the first garment, the first feature information includes first limb region information of the first object, first limb key point information, first limb pose information and first limb segmentation information, the first limb region information includes garment information of the first garment, and the first limb segmentation information includes body shape and pose information of the first object.

In an optional implementation, the second feature information includes: second limb region information, second limb key point information, second limb pose information and second limb segmentation information of the object to be garment-replaced, the second limb segmentation information including the body shape and pose information of the object to be garment-replaced, and the second limb region information including a predetermined protection region of the object to be garment-replaced belonging to a non-garment wearing region.

In an optional implementation, the feature extraction module includes a first feature extractor and a second feature extractor,

The first determining module 420 is specifically configured to: process the first feature information with the first feature extractor to obtain the plurality of first feature maps, wherein sizes of the plurality of first feature maps are different, and process the second feature information with the second feature extractor to obtain the plurality of second feature maps, wherein sizes of the plurality of second feature maps are different.

In an optional implementation, the generative model further including: a latent variable extractor, the feature extraction module determining a target feature extraction result further based on the second feature information, and the apparatus further includes:
An extraction module (not shown in the figure) configured to extract, from the target feature extraction result based on the latent variable extractor, a body shape and pose vector representing a body shape feature and a pose feature of the object to be garment-replaced, and
The second determining module 430 is specifically configured to: determine the target generative image based on the plurality of first feature maps, the plurality of second feature maps, the body shape and pose vector, the initial intermediate feature and the initial generative image.

In an optional implementation, the deformation generative module includes a plurality of feature deformation generators set in series, and output image sizes corresponding to the plurality of feature deformation generators are sequentially increased, and the plurality of first feature maps and the plurality of second feature maps include: a first feature map and a second feature map respectively corresponding to each of the feature deformation generators, the second determining module 430 includes: a first processing unit (not shown in the figure) configured to process, with any target feature deformation generator among the plurality of feature deformation generators, a current intermediate feature based on a first feature map and a second feature map corresponding to the feature deformation generator, and the body shape and pose vector, to obtain an updated intermediate feature, the current intermediate feature being an intermediate feature output by a previous feature deformation generator of the target feature deformation generator, or the initial intermediate feature; a first obtaining unit (not shown in the figure) configured to obtain an updated generative image based on the updated intermediate feature and the current generative image, to obtain the target generative image, wherein the current generative image is a generative image output by a previous feature deformation generator of the target feature deformation generator, or the initial generative image.

In an optional implementation, the second determining module 430 further includes: a first determining unit (not shown in the figure) configured to, in response to the target feature deformation generator being a feature deformation generator at the end, determine the target generative image based on the obtained updated generative image.

In an optional implementation, the first obtaining unit is specifically configured to perform a deformation occluding operation on a first feature map corresponding to the target feature deformation generator with current deformation occlusion information to obtain a first feature map after deformation occlusion, the current deformation occlusion information being deformation occlusion information output by a previous feature deformation generator of the target feature deformation generator, or initial deformation occlusion information obtained by initialization; process the current intermediate feature with the body shape and pose vector to obtain a first intermediate feature; and connect the deformed and occluded first feature map, the second feature map corresponding to the target feature deformation generator, and the first intermediate feature to obtain the updated intermediate feature of the target feature deformation generator.

In an optional implementation, the current deformation occlusion information includes current optical flow field information and current occlusion information, the current occlusion information including predicted occlusion information for protecting a background region of the second image and predicted occlusion information for protecting a predetermined protection region in the second image, the current optical flow field information at least including a predicted correspondence between a first garment in the first image and an object to be garment-replaced in the second image.

In an optional implementation, the first obtaining unit is further configured to determine, based on the updated intermediate feature and the current deformation occlusion information, updated deformation occlusion information of the target feature deformation generator.

In an optional implementation, the generative model further includes: a fuser; the second determining module 430 is configured to fuse, with the fuser, to obtain the target generative image based on the updated generative image, a background image including the background region of the second image, a protection region image including the determined protection region and target occlusion information output by a feature deformation generator at the end.

In an optional implementation, as shown in FIG. 5, the apparatus further includes: a second obtaining module 510 configured to obtain first sample feature information including sample garment information of a sample garment from an initial image, and obtaining second sample feature information including body shape and pose information of a target object to be garment-replaced from a target image corresponding to the initial image; a third determining module 520 configured to, with the feature extraction module, determine a plurality of first sample feature maps based on the first sample feature information, and determining a plurality of second sample feature maps based on the second sample feature information, the plurality of second sample feature maps including body shape features and pose features corresponding to the body shape and pose information of the target object; a fourth determining module 530 configured to, with the deformation generative module, determine a target prediction image based on the plurality of first sample feature maps, the plurality of second sample feature maps, a randomly generated intermediate feature, and a corresponding randomly generated prediction image, the target prediction image including the target object wearing a deformed sample garment, and the deformed sample garment conforming to a body shape feature and pose feature of the target object; a fifth determining module 540 configured to determine a current prediction loss based on the target prediction image and the target image; and an adjusting module 550 configured to adjust a model parameter of the garment replacement model based on the current prediction loss.

Corresponding to the method embodiments, reference may be made to the description of the method embodiment, and details are not described herein again. The apparatus embodiment is obtained based on a corresponding method embodiment, and has the same technical effect as the corresponding method embodiment, and the detailed description may refer to the corresponding method embodiment.

According to the method and apparatus for virtual garment replacing based on a garment replacement model provided by the embodiment of the present disclosure, the garment replacement model includes a generative model, and the generative model includes a generative model that includes a feature extraction module and a deformation generative module; the method includes: obtaining first feature information including garment information of a first garment from a first image, and obtaining second feature information including body shape and pose information of an object to be garment-replaced from a second image corresponding to the first image; with the feature extraction module, determining a plurality of first feature maps based on the first feature information, and determining a plurality of second feature maps based on the second feature information, the plurality of second feature maps including body shape features and pose features corresponding to the body shape and pose information of the object to be garment-replaced; and with the deformation generative module, determining a target generative image based on the plurality of first feature maps, the plurality of second feature maps, a randomly generated initial intermediate feature and a corresponding randomly generated initial generative image, the target generative image including an object to be garment-replaced wearing a deformed first garment, and the deformed first garment conforming to the body shape feature and pose feature of the object to be garment-replaced. In the above process, the input second feature information includes the body shape and pose information of the object to be garment-replaced, so that the garment replacement model may extract the body shape feature and the pose feature of the object to be garment-replaced in the second image, so that the shape and the deformation of the deformed first garment may be more attached to the body shape feature and the pose feature of the object to be garment-replaced, and the generated target generation image includes the object with the body shape more attached to the body shape feature and the pose feature of the object to be garment-replaced, so that the real change effect of changing the object to be garment-replaced is implemented.

FIG. 6 is a schematic structural diagram of an electronic device 600 suitable for implementing embodiments of the present specification. The electronic device shown in FIG. 6 is merely an example, and should not impose any limitation on the functions and scope of use of the embodiments of the present specification.

As shown in FIG. 6, the electronic device 600 may include a processing device (for example, a central processing unit, a graphics processor, etc.) 601, which may perform various appropriate actions and processing according to a program stored in a read-only memory (ROM) 602 or a program loaded into a random access memory (RAM) 603 from a storage device 608. In the RAM 603, various programs and data required by the operation of the electronic device 600 are also stored. The processing device 601, the ROM 602, and the RAM603 are connected to each other through a bus 604. An input/output (I/O) interface 605 is also connected to bus 604.

Generally, the following devices may be connected to the I/O interface 605: an input device 606 including, for example, a touch screen, a touch pad, a keyboard, a mouse, etc.; an output device 607 including, for example, a liquid crystal display (LCD), a speaker, a vibrator, etc.; a storage device 608 including, for example, a magnetic tape, a hard disk, etc.; and a communication device 609. The communication device 609 may allow the electronic device 600 to communicate wirelessly or wired with other devices to exchange data. While FIG. 6 shows an electronic device 600 having various devices, it would be appreciated that it is not required to implement or have all illustrated devices. More or fewer devices may alternatively be implemented or provided. Each block shown in FIG. 6 may represent one apparatus, or may represent multiple apparatuses as required.

In particular, according to an embodiment of the present specification, the process described above with reference to the flowchart may be implemented as a computer software program. For example, embodiments of the present specification include a computer program product including a computer program embodied on a computer readable medium, the computer program including program code for performing the method shown in the flowchart. In such embodiments, the computer program may be downloaded and installed from the network through the communication device 609, or installed from the storage device 608, or from the ROM 602. When the computer program is executed by the processing apparatus 601, the foregoing functions defined in the method of the embodiments of this specification are performed.

An embodiment of the present specification further provides a computer-readable storage medium having a computer program stored thereon, and when the computer program is executed in a computer, the computer is enabled to execute the method for virtual garment replacing based on the garment replacement model.

It would be appreciated that the computer readable medium described in the embodiments of the present specification may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In embodiments of the present specification, a computer-readable storage medium may be any tangible medium containing or storing a program that may be used by or in connection with an instruction execution system, apparatus, or device. In an embodiment of the present specification, a computer readable signal medium may include a data signal propagated in baseband or as part of a carrier, wherein the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

The computer-readable medium described above may be included in the electronic device; or may be separately present without being assembled into the electronic device. The computer readable medium carries one or more programs, and when the one or more programs are executed by the electronic device, the electronic device is caused to: obtain first feature information including garment information of a first garment from a first image, and obtain second feature information including body shape and pose information of an object to be garment-replaced from a second image corresponding to the first image; with the feature extraction module, determine a plurality of first feature maps based on the first feature information, and determining a plurality of second feature maps based on the second feature information, the plurality of second feature maps including body shape features and pose features corresponding to the body shape and pose information of the object to be garment-replaced; and with the deformation generative module, determine a target generative image based on the plurality of first feature maps, the plurality of second feature maps, a randomly generated initial intermediate feature and a corresponding randomly generated initial generative image, the target generative image including an object to be garment-replaced wearing a deformed first garment, and the deformed first garment conforming to the body shape feature and pose feature of the object to be garment-replaced.

Computer program code for performing the operations of embodiments of the present specification may be written in one or more programming languages, including object oriented programming languages, such as Java, Smalltalk, C++, and conventional procedural programming languages, such as the ‘C’ language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local region network (LAN) or a wide region network (WAN), or may be connected to an external computer (e.g., connected through the Internet using an Internet service provider).

Various embodiments in this specification are described in a progressive manner, and parts that are the same and similar between the embodiments may be referred to each other, and each embodiment focuses on differences from other embodiments. In particular, for the storage medium and the computing device embodiment, since it is substantially similar to the method embodiment, the description is relatively simple, and reference may be made to some descriptions of the method embodiments at the relevant parts.

Those skilled in the art should appreciate that, in one or more of the above examples, the functions described in the embodiments of the present disclosure may be implemented in hardware, software, firmware, or any combination thereof. When implemented using software, these functions may be stored in a computer-readable medium or transmitted as one or more instructions or code on a computer-readable medium.

The objects, technical solutions and beneficial effects of the embodiments of the present disclosure are further described in further detail with reference to the specific embodiments described above. It would be appreciated that the above descriptions are only specific embodiments of the embodiments of the present disclosure, and are not intended to limit the protection scope of the present disclosure, and any modification, equivalent substitution, improvement and the like made on the basis of the technical solutions of the present disclosure would be included within the protection scope of the present disclosure.

1-14. (canceled)

15. A method for virtual garment replacing based on a garment replacement model, comprising:
obtaining first feature information comprising garment information of a first garment from a first image, and obtaining second feature information comprising body shape and pose information of an object to be garment-replaced from a second image corresponding to the first image, wherein the garment replacement model comprises a generative model that comprises a feature extraction module and a deformation generative module;
with the feature extraction module, determining a plurality of first feature maps based on the first feature information, and determining a plurality of second feature maps based on the second feature information, the plurality of second feature maps comprising body shape features and pose features corresponding to the body shape and pose information of the object to be garment-replaced; and
with the deformation generative module, determining a target generative image based on the plurality of first feature maps, the plurality of second feature maps, a randomly generated initial intermediate feature and a corresponding randomly generated initial generative image, the target generative image comprising an object to be garment-replaced wearing a deformed first garment, and the deformed first garment conforming to the body shape feature and pose feature of the object to be garment-replaced.

16. The method of claim 15, wherein the first image comprises a first object wearing the first garment, the first feature information comprises first limb region information of the first object, first limb key point information, first limb pose information and first limb segmentation information, the first limb region information comprises garment information of the first garment, and the first limb segmentation information comprises body shape and pose information of the first object.

17. The method of claim 15, wherein the second feature information comprises: second limb region information, second limb key point information, second limb pose information and second limb segmentation information of the object to be garment-replaced, the second limb segmentation information comprising the body shape and pose information of the object to be garment-replaced, and the second limb region information comprising a predetermined protection region of the object to be garment-replaced belonging to a non-garment wearing region.

18. The method of claim 15, wherein the feature extraction module comprises a first feature extractor and a second feature extractor,
wherein determining the plurality of first feature maps based on the first feature information comprises:
processing the first feature information with the first feature extractor to obtain the plurality of first feature maps, wherein sizes of the plurality of first feature maps are different, and
wherein determining the plurality of second feature maps based on the second feature information comprises:
processing the second feature information with the second feature extractor to obtain the plurality of second feature maps, wherein sizes of the plurality of second feature maps are different.

19. The method of claim 15, wherein the generative model further comprises: a latent variable extractor, the feature extraction module determining a target feature extraction result further based on the second feature information, wherein the method further comprises:
extracting, from the target feature extraction result based on the latent variable extractor, a body shape and pose vector representing a body shape feature and a pose feature of the object to be garment-replaced, and
wherein determining the target generative image based on the plurality of first feature maps, the plurality of second feature maps, the initial intermediate feature and the corresponding initial generative image comprises:
determining the target generative image based on the plurality of first feature maps, the plurality of second feature maps, the body shape and pose vector, the initial intermediate feature and the initial generative image.

20. The method of claim 19, wherein the deformation generative module comprises a plurality of feature deformation generators set in series, and output image sizes corresponding to the plurality of feature deformation generators are sequentially increased,
wherein the plurality of first feature maps and the plurality of second feature maps comprise: a first feature map and a second feature map respectively corresponding to each of the feature deformation generators, and
wherein determining the target generative image comprises:
processing, with any target feature deformation generator among the plurality of feature deformation generators, a current intermediate feature based on a first feature map and a second feature map corresponding to the feature deformation generator, and the body shape and pose vector, to obtain an updated intermediate feature, the current intermediate feature being an intermediate feature output by a previous feature deformation generator of the target feature deformation generator, or the initial intermediate feature; and
obtaining an updated generative image based on the updated intermediate feature and the current generative image, to obtain the target generative image, wherein the current generative image is a generative image output by a previous feature deformation generator of the target feature deformation generator, or the initial generative image.

21. The method of claim 20, wherein in response to the target feature deformation generator being a feature deformation generator at the end, the target generative image is determined based on the obtained updated generative image.

22. The method of claim 20, wherein obtaining the updated intermediate feature comprises:
performing a deformation occluding operation on a first feature map corresponding to the target feature deformation generator with current deformation occlusion information to obtain a first feature map after deformation occlusion, the current deformation occlusion information being deformation occlusion information output by a previous feature deformation generator of the target feature deformation generator, or initial deformation occlusion information obtained by initialization;
processing the current intermediate feature with the body shape and pose vector to obtain a first intermediate feature; and
obtaining an updated intermediate feature of the target feature deformation generator based on the first feature map after deformation occlusion, the second feature map corresponding to the target feature deformation generator, and the first intermediate feature.

23. The method of claim 22, wherein the current deformation occlusion information comprises current optical flow field information and current occlusion information, the current occlusion information comprising predicted occlusion information for protecting a background region of the second image and predicted occlusion information for protecting a predetermined protection region in the second image, the current optical flow field information at least comprising a predicted correspondence between a first garment in the first image and an object to be garment-replaced in the second image.

24. The method of claim 22, further comprising:
determining, based on the updated intermediate feature and the current deformation occlusion information, updated deformation occlusion information of the target feature deformation generator.

25. The method of claim 23, wherein the generative model further comprises:
a fuser, and
wherein determining the target generative image based on the updated generative image comprises:
fusing, with the fuser, to obtain the target generative image based on the updated generative image, a background image comprising the background region of the second image, a protection region image comprising the determined protection region and target occlusion information output by a feature deformation generator at the end.

26. The method of claim 15, further comprising:
obtaining first sample feature information comprising sample garment information of a sample garment from an initial image, and obtaining second sample feature information comprising body shape and pose information of a target object to be garment-replaced from a target image corresponding to the initial image;
with a feature extraction module, determining a plurality of first sample feature maps based on the first sample feature information, and determining a plurality of second sample feature maps based on the second sample feature information, the plurality of second sample feature maps comprising body shape features and pose features corresponding to the body shape and pose information of the target object;
with a deformation generative module, determining a target prediction image based on the plurality of first sample feature maps, the plurality of second sample feature maps, a randomly generated intermediate feature, and a corresponding randomly generated prediction image, the target prediction image comprising the target object wearing a deformed sample garment, and the deformed sample garment conforming to a body shape feature and pose feature of the target object;
determining a current prediction loss based on the target prediction image and the target image; and
adjusting a model parameter of the garment replacement model based on the current prediction loss.

27. An electronic device, comprising a memory and a processor, wherein the memory stores executable code, which, when executed by the processor, perform acts comprising:
obtaining first feature information comprising garment information of a first garment from a first image, and obtaining second feature information comprising body shape and pose information of an object to be garment-replaced from a second image corresponding to the first image;
with a feature extraction module, determining a plurality of first feature maps based on the first feature information, and determining a plurality of second feature maps based on the second feature information, the plurality of second feature maps comprising body shape features and pose features corresponding to the body shape and pose information of the object to be garment-replaced; and
with a deformation generative module, determining a target generative image based on the plurality of first feature maps, the plurality of second feature maps, a randomly generated initial intermediate feature and a corresponding randomly generated initial generative image, the target generative image comprising an object to be garment-replaced wearing a deformed first garment, and the deformed first garment conforming to the body shape feature and pose feature of the object to be garment-replaced.

28. The electronic device of claim 27, wherein the first image comprises a first object wearing the first garment, the first feature information comprises first limb region information of the first object, first limb key point information, first limb pose information and first limb segmentation information, the first limb region information comprises garment information of the first garment, and the first limb segmentation information comprises body shape and pose information of the first object.

29. The electronic device of claim 27, wherein the second feature information comprises: second limb region information, second limb key point information, second limb pose information and second limb segmentation information of the object to be garment-replaced, the second limb segmentation information comprising the body shape and pose information of the object to be garment-replaced, and the second limb region information comprising a predetermined protection region of the object to be garment-replaced belonging to a non-garment wearing region.

30. The electronic device of claim 27, wherein the feature extraction module comprises a first feature extractor and a second feature extractor,
wherein determining the plurality of first feature maps based on the first feature information comprises:
processing the first feature information with the first feature extractor to obtain the plurality of first feature maps, wherein sizes of the plurality of first feature maps are different, and
wherein determining the plurality of second feature maps based on the second feature information comprises:
processing the second feature information with the second feature extractor to obtain the plurality of second feature maps, wherein sizes of the plurality of second feature maps are different.

31. The electronic device of claim 27, wherein the generative model further comprises: a latent variable extractor, the feature extraction module determining a target feature extraction result further based on the second feature information, wherein the acts further comprise:
extracting, from the target feature extraction result based on the latent variable extractor, a body shape and pose vector representing a body shape feature and a pose feature of the object to be garment-replaced, and
wherein determining the target generative image based on the plurality of first feature maps, the plurality of second feature maps, the initial intermediate feature and the corresponding initial generative image comprises:
determining the target generative image based on the plurality of first feature maps, the plurality of second feature maps, the body shape and pose vector, the initial intermediate feature and the initial generative image.

32. The electronic device of claim 31, wherein the deformation generative module comprises a plurality of feature deformation generators set in series, and output image sizes corresponding to the plurality of feature deformation generators are sequentially increased,
the plurality of first feature maps and the plurality of second feature maps comprise: a first feature map and a second feature map respectively corresponding to each of the feature deformation generators, and
wherein determining the target generative image comprises:
processing, with any target feature deformation generator among the plurality of feature deformation generators, a current intermediate feature based on a first feature map and a second feature map corresponding to the feature deformation generator, and the body shape and pose vector, to obtain an updated intermediate feature, the current intermediate feature being an intermediate feature output by a previous feature deformation generator of the target feature deformation generator, or the initial intermediate feature; and
obtaining an updated generative image based on the updated intermediate feature and the current generative image, to obtain the target generative image, wherein the current generative image is a generative image output by a previous feature deformation generator of the target feature deformation generator, or the initial generative image.

33. The electronic device of claim 32, wherein in response to the target feature deformation generator being a feature deformation generator at the end, the target generative image is determined based on the obtained updated generative image.

34. A non-transitory computer-readable storage medium having a computer program stored thereon, wherein the computer program, when executed by a processor, perform acts comprising:
obtaining first feature information comprising garment information of a first garment from a first image, and obtaining second feature information comprising body shape and pose information of an object to be garment-replaced from a second image corresponding to the first image;
with a feature extraction module, determining a plurality of first feature maps based on the first feature information, and determining a plurality of second feature maps based on the second feature information, the plurality of second feature maps comprising body shape features and pose features corresponding to the body shape and pose information of the object to be garment-replaced; and
with a deformation generative module, determining a target generative image based on the plurality of first feature maps, the plurality of second feature maps, a randomly generated initial intermediate feature and a corresponding randomly generated initial generative image, the target generative image comprising an object to be garment-replaced wearing a deformed first garment, and the deformed first garment conforming to the body shape feature and pose feature of the object to be garment-replaced.
